(19) United States
(12) Patent Application Publication
(10) Pub. No.: US 2012/0153587 A1
(43) Pub. Date: Jun. 21, 2012

(54) Toolless Assembly of Hand Trucks and Other Items

(75) Inventors: Paul Ryan, Wichita, KS (US); Robert A. Wood, Lincoln, NE (US)

(73) Assignee: DG Manufacturing, LLC

(21) Appl. No.: 13/329,973

(22) Filed: Dec. 19, 2011

Related U.S. Application Data
(60) Provisional application No. 61/424,478, filed on Dec. 17, 2010.
(60) Provisional application No. 61/424,421, filed on Dec. 17, 2010.

(51) Int. Cl. B62B 1/00; F16B 7/00

(52) U.S. Cl. 280/47.27; 403/315

(57) ABSTRACT

A hand truck comprising: (1) a frame assembly, (2) a nose plate that is disposed adjacent a lower end of the frame assembly, and (3) a wheel assembly that is attached adjacent a lower end of the frame assembly and that is adapted to facilitate the rolling movement of the hand truck relative to a support surface. Various components of the hand truck are adapted to allow a user to assemble the hand truck substantially without (e.g., without) the use of tools.

### CROSS REFERENCE TO RELATED APPLICATIONS

This application claims the benefit of U.S. Provisional Application No. 61/424,478, entitled “Hand Trucks and Hand Truck Assembly Methods,” filed Dec. 17, 2010, which is incorporated herein by reference, and U.S. Provisional Application No. 61/424,421, entitled “Expandable and Convertible Hand Trucks,” filed Dec. 17, 2010, both of which are incorporated herein by reference.

### BACKGROUND

Hand trucks are often difficult and time consuming to assemble. Accordingly, there is a need for improved hand trucks that are relatively easy for a user to assemble.

### SUMMARY OF THE INVENTION

A hand truck, according to various embodiments, comprises: (1) a frame assembly; (2) a nose plate disposed adjacent a lower end of the fame assembly; and (3) a wheel assembly that is attached adjacent a lower end of the frame assembly, and that comprises at least one wheel that is adapted to facilitate the rolling movement of the hand truck over a support surface supporting the hand truck. In particular embodiments, the frame assembly comprises: (1) a first side frame assembly; (2) a second side frame assembly that is spaced apart from and co-facing the first side frame assembly; and (3) at least one central connector that extends between the first side frame assembly and the second side frame assembly. In certain embodiments, the nose plate is adapted to allow a user to attach the nose plate to the hand truck at least substantially without the use of tools.

An assembly, according to various embodiments, comprises: (1) a first part defining at least one opening and that comprises a finger that is adapted to flex about a base, and disposed adjacent the at least one opening; and (2) a second part that comprises at least one projection that extends from the second part and comprises a first end having a lip and a second end. In certain embodiments, the at least one projection is adapted to allow a user to insert the at least one projection into the at least one opening and to thereby flex the finger about a base of the finger away from a home position of the finger as the user inserts the at least one projection through the at least one opening. In particular embodiments, the lip of the at least one projection is adapted to engage at least a portion of an outer face of the first part when the user fully inserts the at least one projection through the at least one opening. In certain embodiments, the finger is adapted to return to (e.g., snap back to) the home position and engage the second end of the projection when the lip engages the at least the portion of the outer face of the first part. In particular embodiments, the finger and lip are adapted to cooperate to maintain the first part and the second part in a connected relationship.

A hand truck, according to various embodiments, comprises: (1) a frame assembly; (2) a nose plate that is attached adjacent a lower end of the frame assembly; and (3) a wheel assembly attached adjacent a lower end of the frame assembly, and that comprises at least one wheel that is adapted to facilitate the rolling movement of the hand truck over a support surface supporting the hand truck. In particular embodiments, the frame comprises: (1) a first elongated tubular member that comprises a first tab that extends outward a distance from a first end of the first elongated tubular member; (2) a second elongated tubular member that comprises a second tab that extends outward a distance from a first end of the second elongated tubular member; (3) at least one central connector that extends between the first elongated tubular member and the second elongated tubular member. In certain embodiments, the at least one central connector defines: (1) a first opening that is sized to correspond to the profile of the first elongated tubular member and is adapted to allow a user to insert the first elongated tubular member into the opening; (2) a second opening that is sized to correspond to the profile of the second elongated tubular member and that is adapted to allow a user to insert the second elongated tubular member into the opening; (3) a first tab notch that is adjacent the first tab when the user at least fully inserts the first elongated tubular member into the first opening; and (4) a second tab notch that is adjacent the second tab when the user at least fully inserts the second elongated tubular member into the second opening. In particular embodiments, the first elongated tubular member is adapted to allow a user to twist the first tab within the first tab notch after the user has at least fully inserted the first elongated tubular member into the first opening. In certain embodiments, the edges that define the first tab notch are adapted to engage and exert opposing forces on the first tab when the user twists the first tab within the first tab notch. In particular embodiments, the first tab notch is adapted to lock the first tab using the opposing forces as the user rotates the first tab toward a narrow end of the first tab notch. In certain embodiments, the second elongated tubular member is adapted to allow a user to twist the second tab within the second tab notch after the user has at least fully inserted the second elongated tubular member into the second opening. In particular embodiments, the edges that define the second tab notch are adapted to engage and exert opposing forces on the second tab when the user twists the second tab within the second tab notch. In certain embodiments, the second tab notch is adapted to lock the second tab using the opposing forces as the user rotates the second tab toward a narrow end of the second tab notch.

### BRIEF DESCRIPTION OF THE DRAWINGS

Having described various embodiments in general terms, reference will now be made to the accompanying drawings, which are not necessarily drawn to scale, and wherein:

FIG. 1 is a front perspective view of an expandable, convertible hand truck according to a first particular embodiment of the disclosed subject matter. In this figure, the hand truck is shown in a substantially vertical, hand truck configuration.

FIGS. 2 and 3 are front perspective views of the hand truck of FIG. 1 in which the hand truck's handle is in an extended position.

FIG. 4 is a front perspective view of the hand truck shown in FIG. 1 in which the hand truck is shown in a platform cart configuration.

FIG. 5 is a front perspective view of the hand truck shown in FIG. 4 in which the hand truck is shown in an extended platform cart configuration.

FIGS. 6-8 are close up views of a locking mechanism that may be used to maintain a hand truck, such as the hand truck of FIG. 1, in a particular extended or unextended orientation. These figures show the hand truck being gradually extended.

FIG. 9 is a front perspective view of a hand truck according to a second embodiment in which the hand truck is shown in a hand truck configuration.

FIG. 10 is a front perspective view of the hand truck of FIG. 9 in which the hand truck's lower handle is in an extended orientation.

FIG. 11 is a front perspective view of the hand truck of FIG. 9 in which the hand truck's upper handle is in an extended orientation.

FIG. 12 is a front perspective view of the hand truck of FIG. 9, in which the hand truck is shown in an unextended platform cart configuration.

FIGS. 13-14 are front perspective views of the hand truck of FIG. 9 in which the hand truck is shown in an extended platform cart configuration.

FIG. 15 is a front perspective view the hand truck of FIG. 9 in which the lower handle is in an extended orientation.

FIG. 16 is a perspective view of a hand truck according to a further embodiment.

FIG. 17 is an exploded view of the hand truck of FIG. 16.

FIG. 18 is a perspective exploded view of a frame of the hand truck of FIG. 16.

FIG. 19 is a perspective view of the frame of the hand truck of FIG. 16 with the wheels and axle removed.

FIG. 20 is a perspective view of the frame of the hand truck of FIG. 16 with the wheels and axle removed.

FIG. 21 is a perspective view of the frame of the hand truck of FIG. 16.

FIG. 22 is a detail view of an upper portion of a first side frame assembly of the hand truck of FIG. 16.

FIG. 23 is a detail view of an upper portion of the first side frame assembly of the hand truck of FIG. 16.

FIG. 24 is a detail view of a middle portion of the first side frame assembly of the hand truck of FIG. 16.

FIG. 25 is a detail view of a middle portion of the first side frame assembly of the hand truck of FIG. 16.

FIG. 26 is a detail exploded view of an extendable frame assembly of the hand truck of FIG. 16.

FIGS. 27-28 are detail views of the extendable frame assembly of the hand truck of FIG. 16 transitioning from an unlocked to a locked position.

FIG. 29 is an exploded view of the frame, the extendable frame assembly, and an upper cart handle of the hand truck of FIG. 16.

FIG. 30 is a perspective view of a further embodiment of a hand truck.

FIG. 31 is a perspective view of a nose plate of the hand truck of FIG. 30.

### DETAILED DESCRIPTION OF VARIOUS EMBODIMENTS

Various embodiments of the disclosed subject matter will now be described more fully hereinafter with reference to the accompanying drawings, in which various embodiments of the disclosed subject matter are shown. The claimed technology may, however, be embodied in many different forms and should not be construed as limited to the embodiments set forth herein. Rather, these embodiments are provided so that this disclosure will be thorough and complete, and will fully convey the scope of the technology to those skilled in the art. Like numbers refer to like elements throughout.

### EXPANDABLE HAND TRUCK

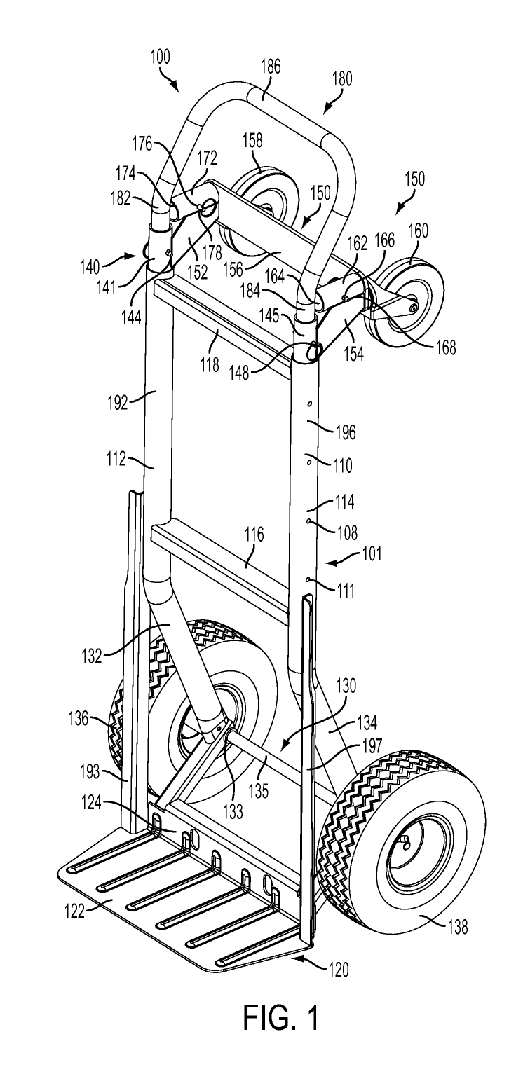

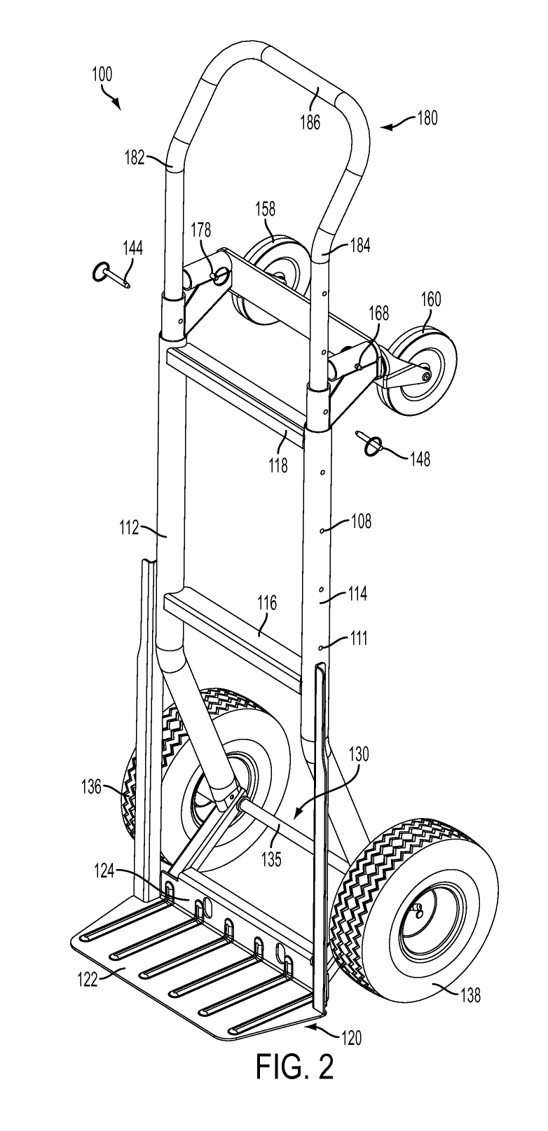

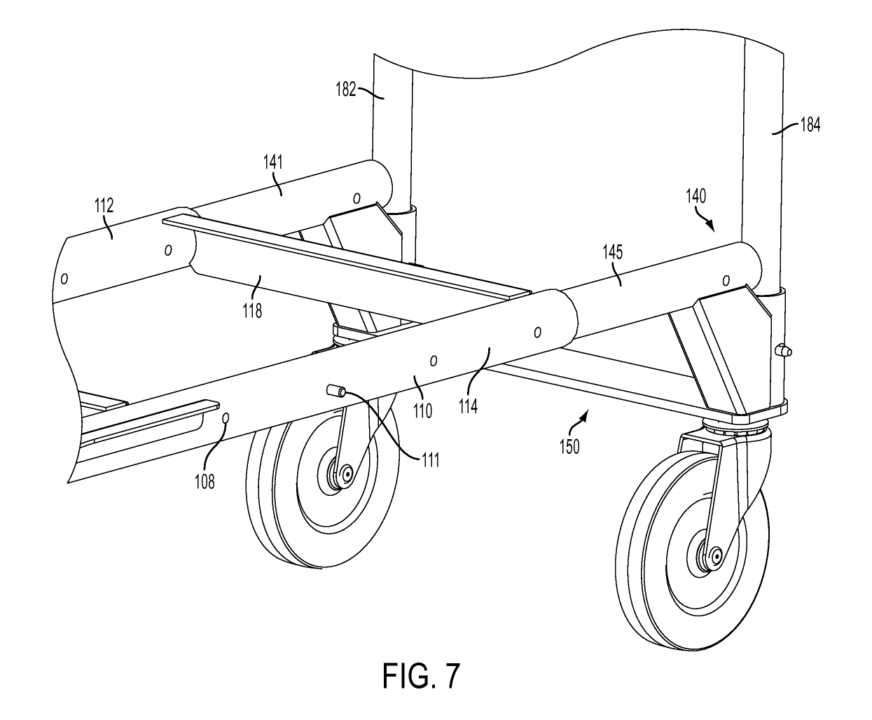

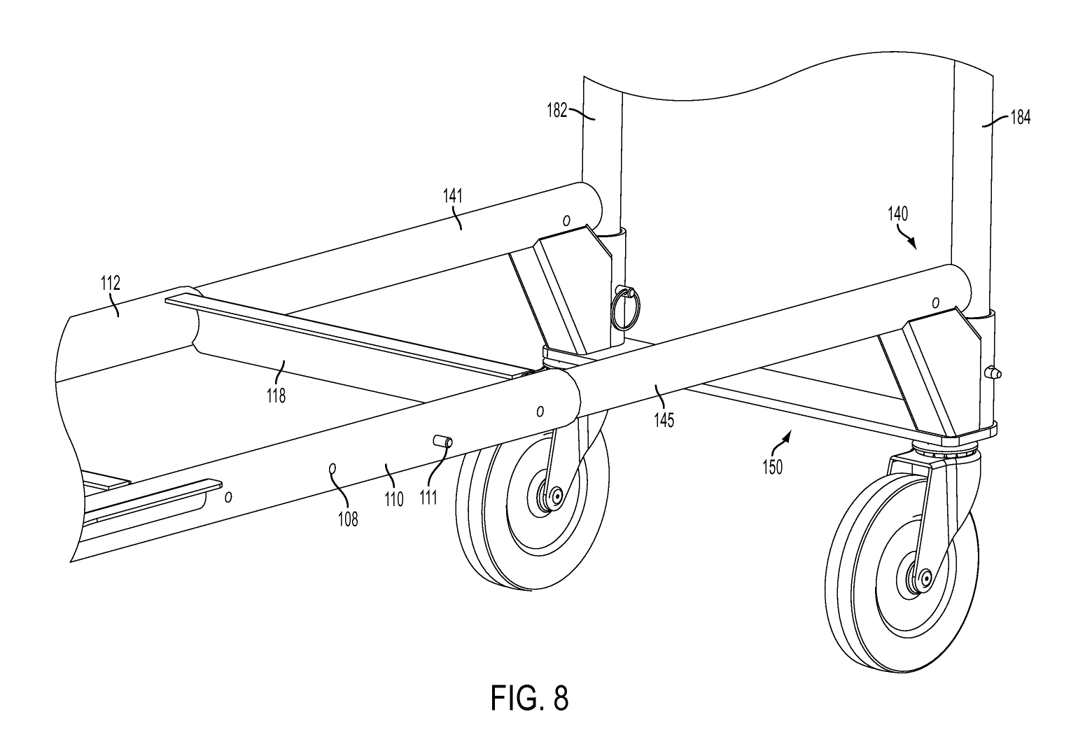

An expandable hand truck 100 according to a particular embodiment is shown in FIGS. 1-8. In this embodiment, the hand truck 100 comprises: (1) a hand truck base portion 101; (2) an extendable frame assembly 140; (3) a secondary wheel assembly 150; and (4) an upper cart handle 180. These components are discussed in greater detail below.

### Hand Truck Base Portion

In particular embodiments, the hand truck base portion 101 may comprise: (1) a frame 110; (2) a nose plate 120; and (3) a primary wheel assembly 130. These components are discussed in greater detail below.

1. Frame

The hand truck base portion 101 may include any suitable type of frame. In the embodiment shown in FIG. 1, this frame 110 includes: (1) a right frame member 112 (which, in this embodiment, is a substantially straight, elongated frame member, which comprises an upper portion 192 and a lower portion 193, and which is adapted to stand in a substantially vertical orientation when the hand truck base portion 101 is in an upright orientation); (2) a left frame member 114, which, in this embodiment, is a substantially straight, elongated frame member, which comprises an upper portion 196 and a lower portion 197, and which is adapted to stand in a substantially vertical orientation when the hand truck base portion 101 is in an upright orientation); and (3) a plurality of crossbars 116, 118 that extend between, and physically connect, the right and left frame members 112, 114.

The various components of the frame 110 may be made of any suitable (preferably sturdy) material (e.g., a suitable metal such as steel or aluminum, or plastic). In various embodiments, these components are secured together using any suitable fastening technique to provide a rigid frame for the hand truck.

2. Nose Plate

The hand truck base portion 101 may include any suitable type of nose plate 120. As shown in FIG. 1, this nose plate 120 may include: (1) a substantially planar support plate 122; and (2) a substantially planar face plate 124 that extends upwardly adjacent a rear edge of the support plate 122. The nose plate 120 is adapted to support a load and may be attached adjacent (e.g., to) a lower end of the hand truck base portion's frame 110 in any suitable manner (e.g., using suitable fasteners or welding techniques).

3. Primary Wheel Assembly

In particular embodiments, the hand truck's primary wheel assembly 130 is adapted for facilitating the movement of the hand truck 100 relative to a support surface that is supporting the hand truck 100. In the embodiment shown in FIG. 1, the primary wheel assembly 130 includes a substantially L-shaped right axle support 132 that extends outwardly and rearwardly adjacent the lower end of the right frame member's upper portion 192, and a substantially L-shaped left axle support 134 that extends outwardly and rearwardly adjacent (e.g., to) the lower end of the left frame member's upper portion 196. The right axle support 132 defines an opening 133 adjacent an apex formed by the right axle support 132, and the left axle support 134 defines a similar opening (not shown) that is adjacent an apex formed by the left axle support 134.

The primary wheel assembly 130 may further include an elongated hand truck axle 135 (see FIG. 1) that extends through the openings 133 in the right and left axle supports 132, 134 so that the axle 135 is substantially parallel to a support surface that supports the hand truck 100 when the hand truck base portion 101 is in an upright orientation. The primary wheel assembly 130 further includes a pair of wheels 136, 138 that are rotatably mounted, respectively, adjacent (e.g., to) opposite ends of the hand truck's axle 135.

### Extendable Frame Assembly

In particular embodiments, the extendable frame assembly 140 is adapted for facilitating the selective conversion of the hand truck 100 between: (1) an unextended configuration and (2) an extended configuration. In the embodiment of FIG. 1, the extendable frame assembly 140 includes: (1) a right extendable frame member 141; (2) a left extendable frame member 145; and (3) a connecting member that connects the right and left extendable frame members 141, 145. These various components are discussed in greater detail below.

1. Right Extendable Frame Member

As shown in FIG. 1, the right extendable frame member 141 may comprise an elongated tube (e.g., a tube having a cross-section that, for example, may be substantially in the shape of a square, circle, oval, or any other suitable shape). The right extendable frame member 141 may be made of any suitable (preferably sturdy) material (e.g., a suitable metal such as steel or aluminum, or plastic).

As shown in FIG. 1, the right extendable frame member 141 may be adapted to fit within the upper portion 192 of the frame's right frame member 112 (which may be, for example, a hollow tube, or other suitable structure). In various embodiments, the inner cross-sectional profile of the upper portion 192 of the right frame member 112 at least substantially corresponds to an outer cross-sectional profile of the right extendable frame member 141. In particular embodiments, the right extendable frame member 141 has an outer diameter that is substantially equal to an inner diameter of the upper portion 192 of the right frame member 112. The respective diameters of the right extendable frame member 141 and upper portion 192 of the right frame member 112 may be chosen to allow the right extendable frame member 141 to translate within the upper portion 192 of the right frame member 112 while maintaining the right extendable frame member 141 in a substantially parallel configuration with the left extendable frame member 145 (e.g., while maintaining a tight fit—e.g., a mating fit—between the right extendable frame member 141 and the upper portion 192 of the right frame member 112).

2. Left Extendable Frame Member

As shown in FIG. 1, the left extendable frame member 145 may comprise an elongated tube (e.g., a tube having a cross-section that, for example, may be substantially in the shape of a square, circle, oval, or any other suitable shape). The left extendable frame member 145 may be made of any suitable (preferably sturdy) material (e.g., a suitable metal such as steel or aluminum, or plastic).

As shown in FIG. 1, the left extendable frame member 145 may be adapted to fit within the upper portion 196 of the frame's left frame member 114 (which may be, for example, a hollow tube, or other suitable structure). In various embodiments, the inner cross-sectional profile of the upper portion 196 of the left frame member 114 at least substantially corresponds to an outer cross-sectional profile of the left extendable frame member 145. In particular embodiments, the left extendable frame member 145 has an outer diameter that is substantially equal to an inner diameter of the upper portion 196 of the left frame member 114. The respective diameters of the left extendable frame member 145 and upper portion 196 of the left frame member 114 may be chosen to allow the left extendable frame member 145 to translate within the upper portion 196 of the left frame member 114 while maintaining the left extendable frame member 145 in a substantially parallel configuration with the right extendable frame member 141 (e.g., while maintaining a tight fit—e.g., a mating fit—between the left extendable frame member 145 and the upper portion 196 of the left frame member 114).

3. Connecting Member

In particular embodiments, the extendable frame assembly 140 comprises a connecting member that, in various embodiments, provides a rigid connection between the upper ends of the right and left extendable frame members 141, 145. In the embodiment shown in FIG. 1, the secondary wheel assembly 150 serves this purpose. However, in other embodiments, another suitable structure may serve in this role.

### Secondary Wheel Assembly

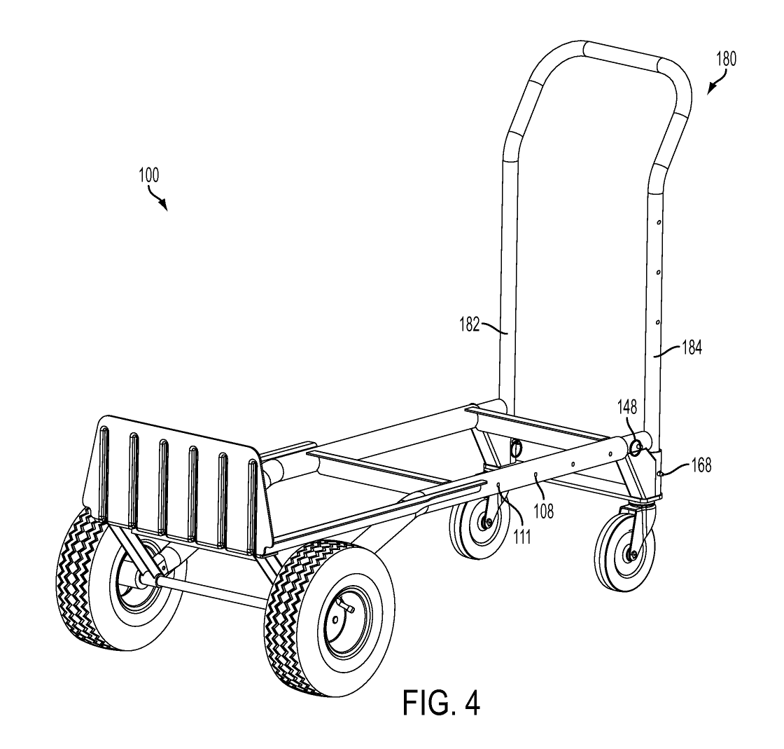

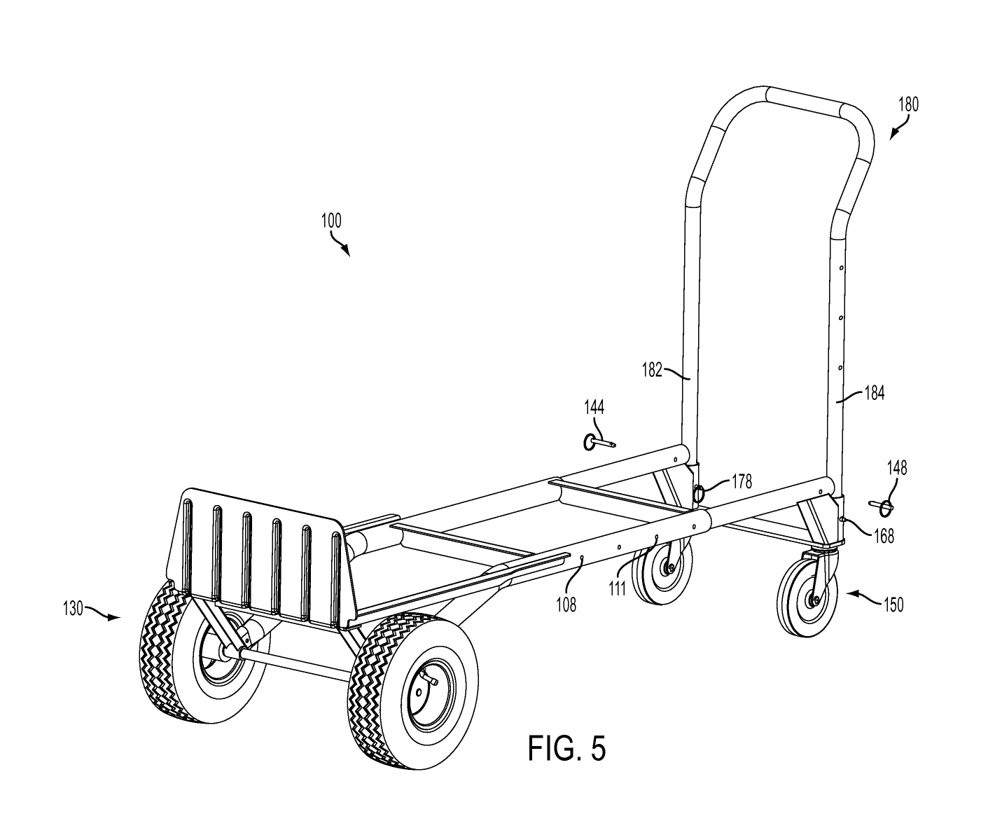

In particular embodiments, the expandable hand truck 100 may further comprise a secondary wheel assembly 150. As may be understood from FIGS. 4-5, in various embodiments, the secondary wheel assembly 150 is adapted for facilitating the movement of the hand truck 100 relative to a support surface supporting the hand truck while the hand truck 100 is in a horizontal orientation (e.g., while the hand truck is in a platform cart orientation). The secondary wheel assembly 150 may be adapted for cooperating with the primary wheel assembly 130 to facilitate a rolling movement of the hand truck 100 over the support surface.

In various embodiments, the secondary wheel assembly 150 comprises at least one wheel that is rotatably attached adjacent the extendable frame assembly 140. For example, in the embodiment shown in FIGS. 1-8, the secondary wheel assembly 150 comprises a pair of secondary wheels 158, 160 (in this case, a pair of caster wheels). As shown in FIG. 1, the secondary wheel assembly 150 may be attached, for example, adjacent the extendable frame assembly 140 (e.g., adjacent the right and left extendable frame members 141, 145).

As may be understood from FIG. 1, in particular embodiments, the secondary wheel assembly 150 comprises a substantially planar central support 156 that is positioned behind an upper portion of the hand truck 100. In particular embodiments, the central support 156 is substantially parallel to the hand truck's front face. In the embodiment shown in FIG. 1, the lateral sides of the central support 156 generally align with respective lateral sides of the hand truck 100.

In various embodiments, the secondary wheel assembly 150 further includes a substantially planar (e.g., rigid) right connector 152 that extends between the right extendable frame member 141 and the right lateral side of the central support 156. Similarly, the secondary wheel assembly 150 also includes a substantially planar (e.g., rigid) left connector 154 that extends between the left extendable frame member 145 and the left lateral side of the central support 156.

In particular embodiments, such as the embodiment of FIG. 1, the secondary wheel assembly 150 includes a left handle support 162 that extends outwardly from a front surface of the central support 156 adjacent the central support's left lateral side. The left handle support 162 defines an interior portion that is adapted for snuggly receiving a lower end of a left handle portion 184 of the hand truck's handle 180 (e.g., through an opening 164 in a distal end of the left handle support 162). As shown in FIG. 1, the left handle support 162 may extend outwardly from the front surface of the central support 156 (e.g., at an angle of about 90 degrees from the front surface of the central support 156).

In the embodiment of FIG. 1, the secondary wheel assembly 150 also includes a right handle support 172 that extends outwardly from a front surface of the central support 156 adjacent the central support's right lateral side. In particular embodiments, the right handle support 172 defines an interior portion that is adapted for snuggly receiving a lower end of a right handle portion 182 of the hand truck's handle 180 (e.g., through an opening 174 in a distal end of the right handle support 172). The right handle support 172 may extend outwardly from the front surface of the central support 156 (e.g., at an angle of about 90 degrees from the front surface of the central support 156). In various embodiments, such as the embodiment of FIG. 1, the right and left handle supports 172, 162 are adapted to cooperate to maintain the hand truck's handle 180 in an orientation that is substantially parallel to the hand truck's nose plate 120.

As shown in FIG. 1, the right and left handle supports 172, 162 may include suitable locking mechanisms for maintaining the ends of the hand truck's handle 180 in a substantially fixed position relative to the hand truck's handle supports 172, 162. One suitable locking mechanism may be, for example, a pin 168, 178 that extends through an opening 166, 176 in one of the hand truck's handle supports 172, 162 and then through a corresponding hole in a side portion of a respective end of the hand truck's handle 180. Although the locking mechanism is shown as a pin arrangement in FIG. 1, any other suitable locking mechanism may be used for this purpose.

As shown in FIG. 1, in particular embodiments, the right and left handle supports 172, 162 are spaced apart from each other by a distance corresponding to the distance between the right and left handle portions 182, 184 of the upper cart handle 180. The exact length of this spacing may vary, for example, from model to model.

### Upper Cart Handle

The hand truck 100 may include any suitable type of upper cart handle 180. As shown in FIG. 1, the upper cart handle 180 may comprise a substantially U-shaped piece of metal tubing. In the embodiment shown in FIG. 1, the upper cart handle 180 comprises: (1) a right handle portion 182; (2) a left handle portion 184; and (3) a central handle portion 186.

The right handle portion 182 may comprise a substantially straight, elongated tube having, for example, a substantially circular (e.g., circular) profile. In alternative embodiments, the right handle portion 182 may have any other suitable profile (e.g., a square, rectangular, or oval profile). As shown in FIG. 1, the right handle portion 182 may be adapted to fit and slide within the right extendable frame member 141. In various embodiments, the right handle portion 182 has a cross sectional profile that at least generally corresponds to the cross sectional profile of the right extendable frame member 141. The dimensions of the inner surface of the right extendable frame member 141 may substantially correspond to (e.g., correspond to) the dimensions of the outer surface of the right handle portion 182 such that the right handle portion 182 can nest within the right extendable frame member 141 with sufficient clearance to facilitate smooth sliding and sufficient snugness to provide rigidity of the hand truck 100 when the upper cart handle 180 is in an extended position.

In particular embodiments, the right extendable frame member 141 is adapted to fit and slide within the right frame member 112. As may be understood from FIG. 1, when the right handle portion 182 is nested within the right extendable frame member 141 and the right extendable frame member 141 is nested within the right frame member 112, the right handle portion 182, the right extendable frame member 141, and the right frame member 112 are maintained in a triple nested relationship with one another.

In various embodiments, the left handle portion 184 may comprise a substantially straight, elongated tube having, for example, a substantially circular (e.g., circular) profile. In alternative embodiments, the left handle portion 184 may have any other suitable profile (e.g., a square, rectangular, or oval profile). As shown in FIG. 1, the left handle portion 184 may be adapted to fit and slide within the left extendable frame member 145. In various embodiments, the left handle portion 184 has a cross sectional profile that corresponds to the cross sectional profile of the left extendable frame member 145. The dimensions of the inner surface of the left extendable frame member 145 may substantially correspond to (e.g., correspond to) the dimensions of the outer surface of the left handle portion 184 such that the left handle portion 184 can nest within the left extendable frame member 145 with sufficient clearance to facilitate smooth sliding and sufficient snugness to provide rigidity of the hand truck 100 when the upper cart handle 180 is in an extended position.

In particular embodiments, the left extendable frame member 145 is adapted to fit and slide within the left frame member 114. As may be understood from FIG. 1, when the left handle portion 184 is nested within the left extendable frame member 145 and the left extendable frame member 145 is nested within the left frame member 114, the left handle portion 184, the left extendable frame member 145, and the left frame member 114 are maintained in a triple nested relationship with one another.

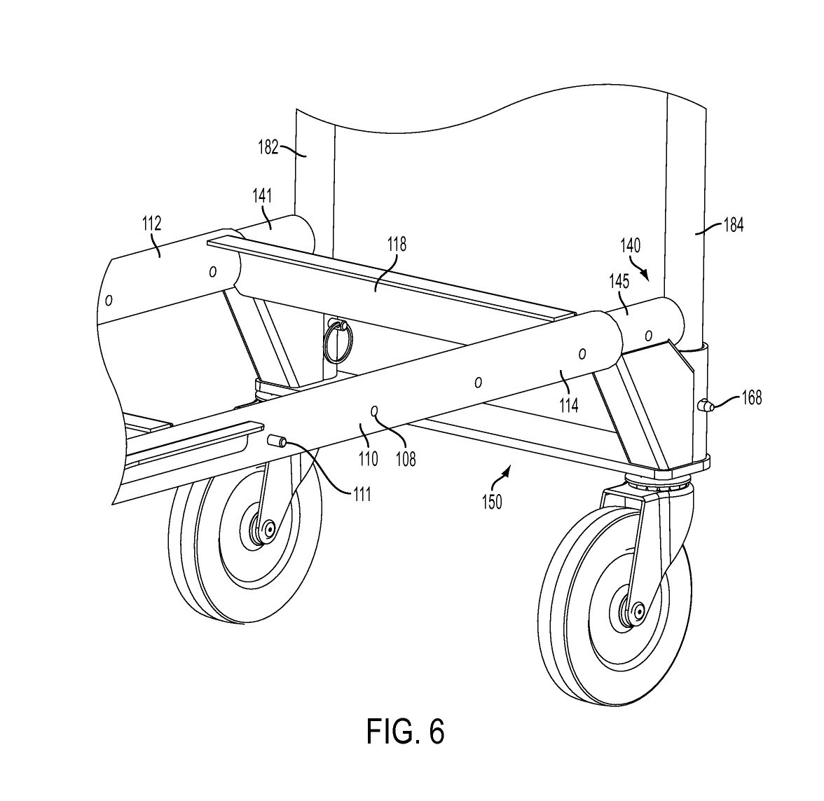

As shown in FIGS. 6-8, one or more spring-loaded buttons 111 may be used to selectively lock the hand truck's frame members in place at different positions relative to the hand truck's frame 110. Each spring loaded button 111 may include a spring that is adapted for biasing the button 111 away from the spring and through one or more holes 108 in the frame 110. In alternative embodiments, any other suitable locking mechanism may be used in place of the spring loaded buttons.

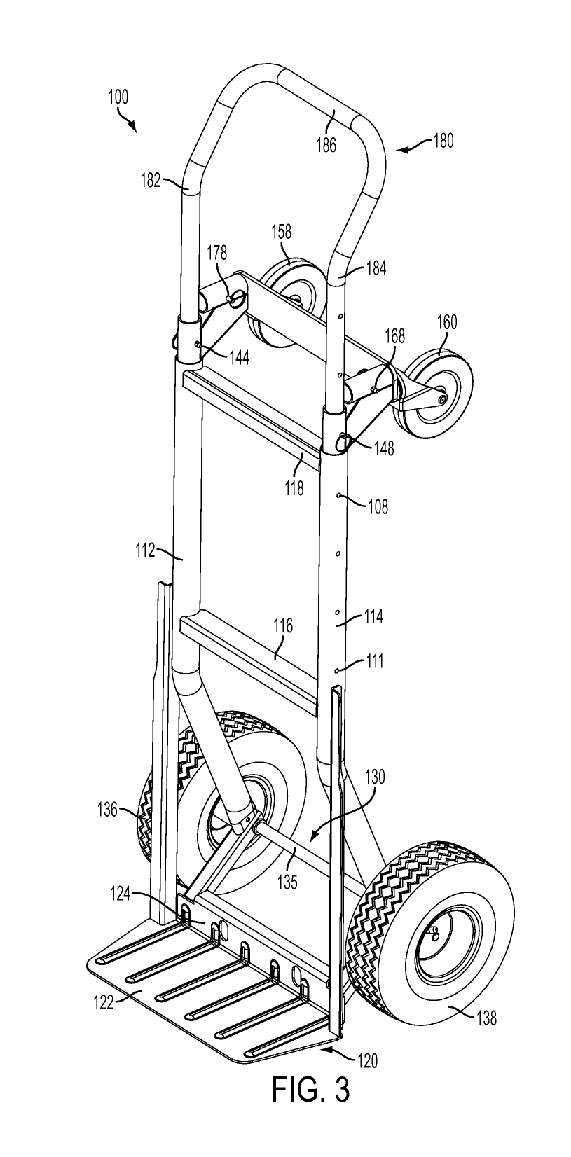

As shown in FIGS. 1-3, the upper cart handle 180 is adapted for selective extension and retraction relative to the hand truck's base portion 101. FIG. 1 shows a particular embodiment of a hand truck 100 with the upper cart handle 180 in a retracted position. FIG. 3 shows a particular embodiment of a hand truck 100 with the upper cart handle 180 in an extended position. In various embodiments, the upper cart handle 180 further comprises a locking mechanism for locking the upper cart handle 180 at various lengths of extension. In the embodiment shown in FIGS. 1-3, the locking mechanism includes pins 144, 148 that lock the upper cart handle 180 in place. Other embodiments may include any other suitable locking mechanism.

### ALTERNATIVE EMBODIMENTS

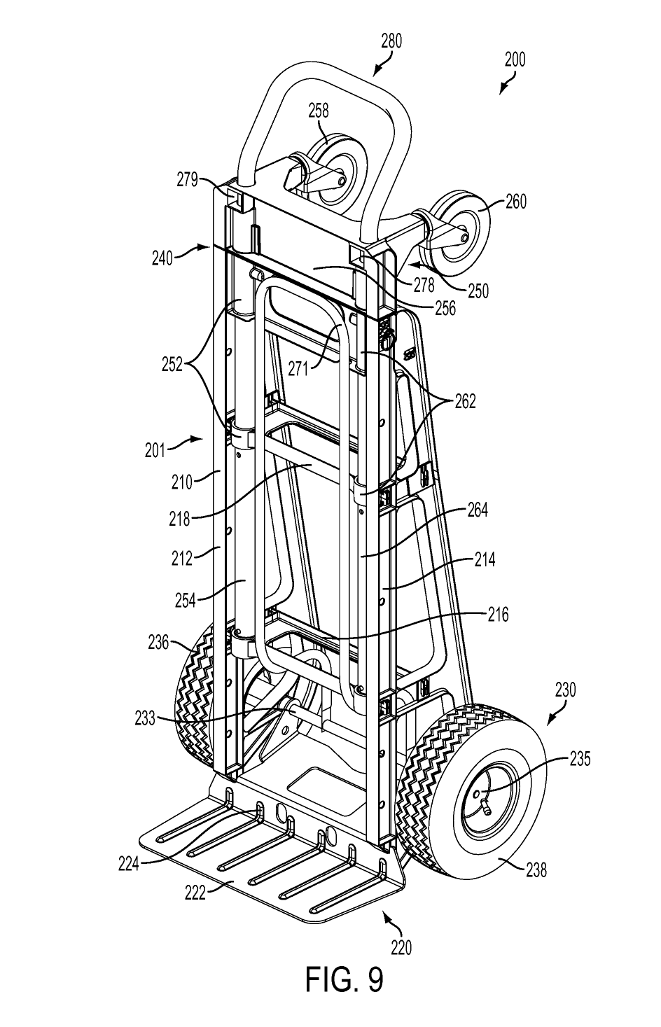

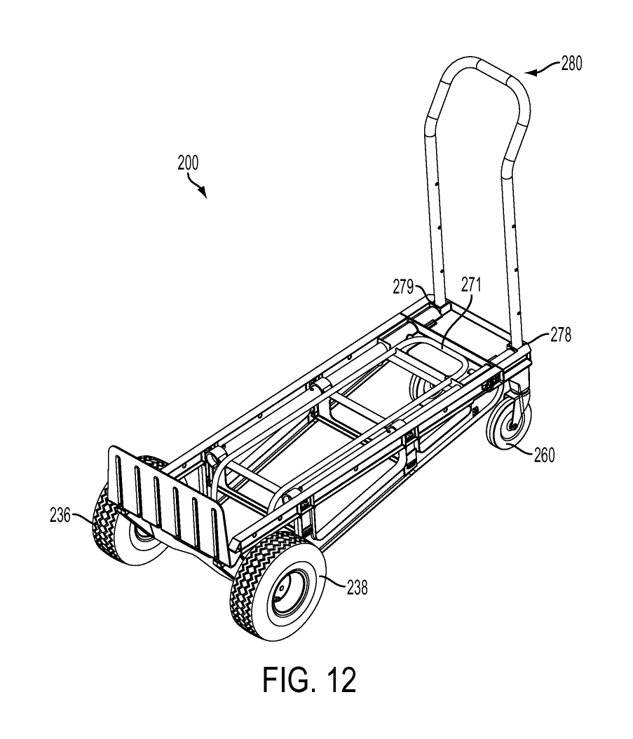

An alternative embodiment of the hand truck is shown in FIGS. 9-15. In this embodiment, much of the hand truck 200 may, for example, be made of a composite material (e.g., plastic). However the basic structure and functionality of the hand truck 200 is similar to that of the hand truck 100 shown in FIGS. 1-8. For example, the embodiment of the hand truck 200 shown in FIGS. 9-15 includes: (1) a hand truck base portion 201; (2) an extendable frame assembly 240; (3) a secondary wheel assembly 250; (4) an upper cart handle 280; and (5) a lower cart handle 271. These various components are discussed in greater detail below.

### Hand Truck Base Portion

In particular embodiments, the hand truck base portion 201 may comprise: (1) a frame 210; (2) a nose plate 220; and (3) a primary wheel assembly 230. These various components are discussed in greater detail below.

1. Frame

The hand truck base portion 201 may include any suitable type of frame. In the embodiment shown in FIG. 9, this frame 210 includes: (1) a right frame member 212 (which, in this embodiment, is in the form of a substantially planar, substantially triangular truss, which is adapted to stand in a substantially vertical orientation when the hand truck base portion 201 is in an upright orientation); (2) a left frame member 214, which, in this embodiment, is also a substantially planar, substantially triangular truss, which is adapted to stand in a substantially vertical orientation when the hand truck base portion 201 is in an upright orientation); and (3) a plurality of crossbars 216, 218 that extend between, and physically connect, the right and left frame members 212, 214.

The various components of the frame 210 may be made of any suitable (preferably sturdy) material (e.g., a suitable metal such as steel or aluminum, or plastic). In various embodiments, these components are secured together using any suitable fastening technique to provide a rigid frame for the hand truck.

2. Nose Plate

The hand truck base portion 201 may include any suitable type of nose plate 220. As shown in FIG. 6, this nose plate 220 may include: (1) a substantially planar support plate 222; and (2) a substantially planar face plate 224 that extends upwardly adjacent a rear edge of the support plate 222. The nose plate 220 is adapted to support a load and may be attached adjacent (e.g., to) a lower end of the hand truck base portion's frame 210 in any suitable manner (e.g., using suitable fasteners or welding techniques).

3. Primary Wheel Assembly

In particular embodiments, the hand truck's primary wheel assembly 230 is adapted for facilitating the movement of the hand truck 200 relative to a support surface that is supporting the hand truck 200. In the embodiment shown in FIG. 9, the primary wheel assembly 230 includes an axle support that includes one or more bearings that may be, for example, attached adjacent, or integrated into, the structure of the right and left frame members 212, 214. In the embodiment shown in FIG. 9, the right and left frame members 212, 214 each include a bearing 233 that defines an opening that is dimensioned for receiving an axle 235 that extends through the opening.

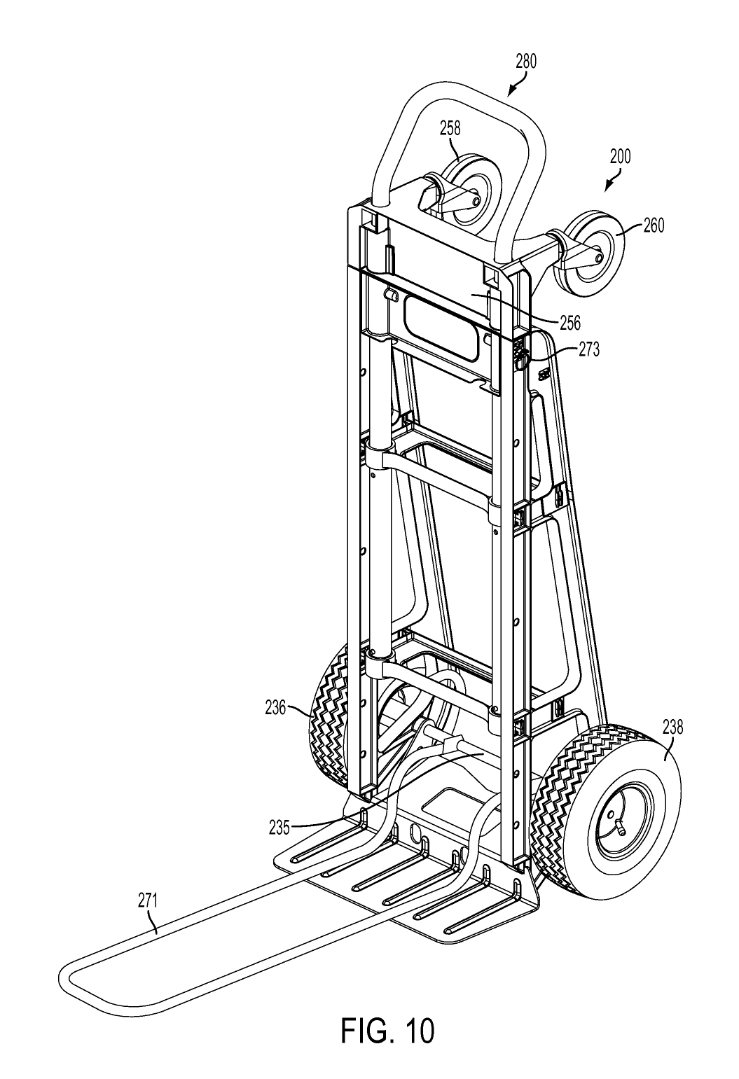

The primary wheel assembly 230 may further include an elongated hand truck axle 235 (See FIGS. 9 and 10) that extends through the openings in the right and left bearings 233 so that the axle 235 is substantially parallel to a support surface that supports the hand truck 200 when the hand truck base portion 201 is in an upright orientation. The primary wheel assembly 230 further includes a pair of wheels 236, 238 that are rotatably mounted, respectively, adjacent (e.g., to) opposite ends of the hand truck's axle 235.

### Extendable Frame Assembly

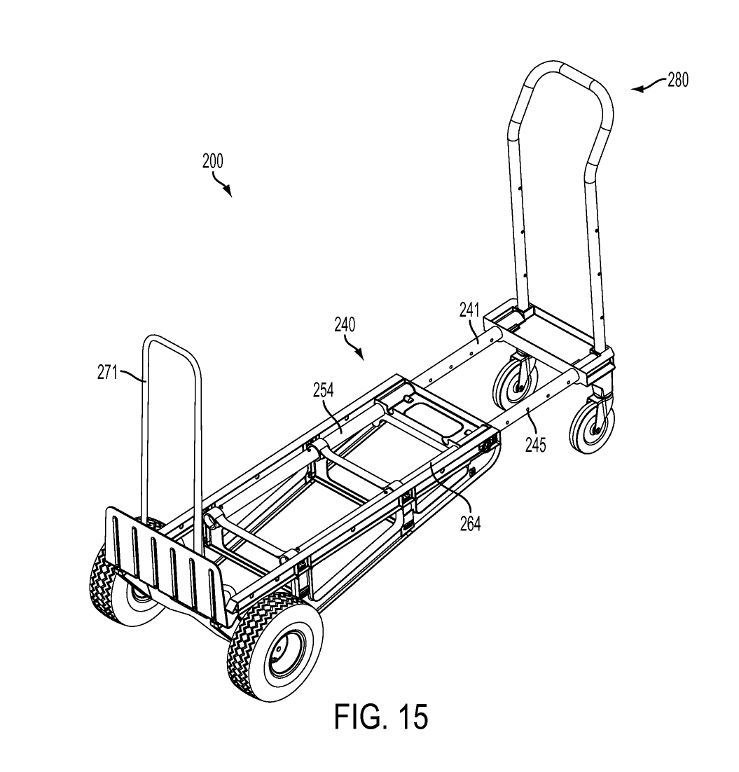

In particular embodiments, the extendable frame assembly 240 is adapted for facilitating the selective conversion of the hand truck 200 between: (1) an unextended configuration and (2) an extended configuration. In the embodiment of FIGS. 9-15, this extendable frame assembly 240 includes: (1) a right extendable frame member 241 (see FIG. 15); (2) a left extendable frame member 245; and (3) a connecting member that connects the right and left extendable frame members 241, 245 together. These various components are discussed in greater detail below.

1. Right Extendable Frame Member

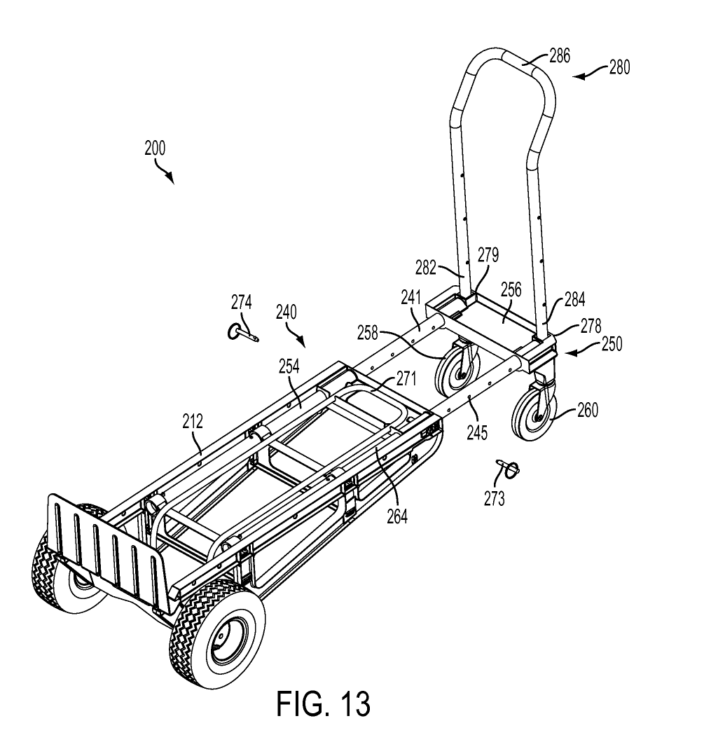

As shown in FIG. 13, the right extendable frame member 241 may comprise an elongated tube (e.g., a tube having a cross-section that, for example, may be substantially in the shape of a square, circle, oval, or any other suitable shape). The right extendable frame member 241 may be made of any suitable (preferably sturdy) material (e.g., a suitable metal such as steel or aluminum, or plastic).

As shown in FIG. 13, the right extendable frame member 241 may be adapted to fit within a first hollow tube 254 (or other suitable structure) that is attached adjacent an interior portion of the frame's right frame member 212 (e.g., via one or more suitable 0 or C shaped supports 252). As shown in FIG. 13, the inner cross-sectional profile of the first hollow tube 254 may at least substantially correspond to an outer cross-sectional profile of the right extendable frame member 241. In particular embodiments, the right extendable frame member 241 has an outer diameter that is substantially equal to an inner diameter of the first hollow tube 254. The respective diameters of the right extendable frame member 241 and first hollow tube 254 may be chosen to allow the right extendable frame member 241 to translate within the first hollow tube 254 while maintaining the right extendable frame member 241 in a substantially parallel configuration with the first hollow tube 254 (e.g., while maintaining a tight fit—e.g., a mating fit—between the right extendable frame member 241 and the first hollow tube 254).

2. Left Extendable Frame Member

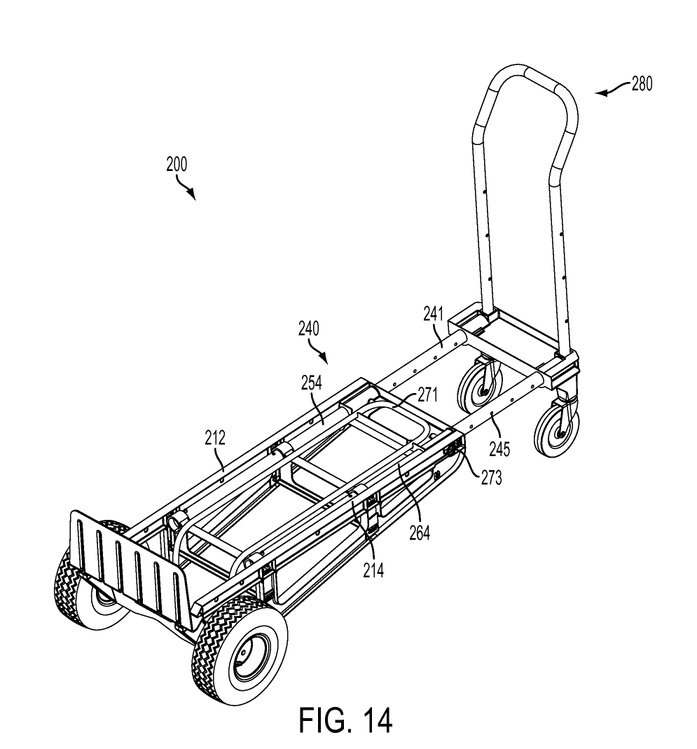

As shown in FIG. 14, the left extendable frame member 245 may comprise an elongated tube (e.g., a tube having a cross-section that, for example, may be substantially in the shape of a square, circle, oval, or any other suitable shape). The left extendable frame member 245 may be made of any suitable (preferably sturdy) material (e.g., a suitable metal such as steel or aluminum, or plastic).

As shown in FIG. 14, the left extendable frame member 245 may be adapted to fit within a second hollow tube 264 (or other suitable structure) that is attached adjacent an interior portion of the frame's left frame member 214 (e.g., via one or more suitable O or C shaped supports 262). As shown in FIG. 14, the inner cross-sectional profile of the second hollow tube 264 may at least substantially correspond to an outer cross-sectional profile of the left extendable frame member 245. In particular embodiments, the left extendable frame member 245 has an outer diameter that is substantially equal to an inner diameter of the second hollow tube 264 of the left frame member 214. The respective diameters of the left extendable frame member 245 and second hollow tube 264 may be chosen to allow the left extendable frame member 245 to translate within the second hollow tube 264 while maintaining the left extendable frame member 245 in a substantially parallel configuration with the second hollow tube 264 (e.g., while maintaining a tight fit—e.g., a mating fit—between the left extendable frame member 245 and the second hollow tube 264).

3. Connecting Member

In particular embodiments, the extendable frame assembly 240 comprises a connecting member that, in various embodiments, provides a rigid connection between the upper ends of the right and left extendable frame members 241, 245. In the embodiment shown in FIG. 13, the secondary wheel assembly 250 serves this purpose. However, in other embodiments, another suitable structure may serve in this role.

### Secondary Wheel Assembly

In particular embodiments, the expandable hand truck 200 comprises a secondary wheel assembly 250. In the embodiment shown in FIG. 13, the secondary wheel assembly 250 is adapted for facilitating the movement of the hand truck 200 relative to a support surface supporting the hand truck 200 while the hand truck 200 is in a horizontal orientation (e.g., while the hand truck 200 is in a platform cart orientation, such as the orientation shown in FIG. 13). The secondary wheel assembly 250 may be adapted for cooperating with the primary wheel assembly 230 to facilitate a rolling movement of the hand truck 200 over the support surface.

In various embodiments, the secondary wheel assembly 250 comprises at least one wheel that is rotatably attached adjacent the extendable frame assembly 240. In the embodiment shown in FIG. 13, the secondary wheel assembly 250 comprises a pair of secondary wheels 258, 260 (in this case, a pair of caster wheels). As shown in FIG. 13, the secondary wheel assembly 250 may be attached, for example, to at least substantially rigidly connect the right and left extendable frame members 241, 245).

As may be understood from FIG. 13, in particular embodiments, the secondary wheel assembly 250 comprises a substantially planar central portion 256 that extends between the respective upper ends of the right and left extendable frame members 241, 245. In particular embodiments, the central support portion 256 is substantially parallel to the hand truck's front face. In the embodiment shown in FIG. 13, the lateral sides of the secondary wheel assembly 250 generally align with respective lateral sides of the hand truck.

In particular embodiments, such as the embodiments of FIGS. 9 and 13, the secondary wheel assembly 250 includes a right handle support 279 that includes a recess defined by the secondary wheel assembly's central support portion 256 adjacent the central support's right lateral side. In particular embodiments, the right handle support 279 is adapted for snuggly receiving a lower end of a right handle portion 282 of the hand truck's handle 280.

In the embodiment of FIGS. 9 and 13, the secondary wheel assembly 250 also includes a left handle support 278 that includes a recess defined by the secondary wheel assembly's central support portion 256 adjacent the central support portion's left lateral side. In particular embodiments, the left handle support 278 is adapted for snuggly receiving a lower end of a left handle portion 284 of the hand truck's handle 280. In various embodiments, such as the embodiment of FIGS. 9 and 13, the left and right handle supports 278, 279 are adapted to cooperate to maintain the hand truck's handle 280 in an orientation that is substantially parallel to the hand truck's nose plate 220.

In various embodiments, the left and right handle supports 278, 279 may include suitable locking mechanisms for maintaining the ends of the hand truck's handle 280 in a substantially fixed position relative to the hand truck's handle supports 278, 279. One suitable locking mechanism may be, for example, a pin that extends through an opening in one of the hand truck's handle supports and then through a corresponding hole in a side portion of a respective end of the hand truck's handle 280. In other embodiments, the right and left handle supports 278, 279 and the hand truck's handle 280 may be dimensioned so that the frictional engagement between portions of the ends of the hand truck's handle 280 and the right and left handle supports 278, 279 is sufficient to maintain the handle 280 in the desired orientation.

As shown in FIG. 14, in particular embodiments, the left and right handle supports 278, 279 are spaced apart from each other by a distance corresponding to the distance between the right and left handle portions 282, 284 of the upper cart handle 280. The exact length of this spacing may vary, for example, from model to model.

### Upper Cart Handle

The hand truck 200 may include any suitable type of upper cart handle 280. As shown in FIGS. 9-15, the upper cart handle 280 may comprise a substantially U-shaped piece of metal tubing. In the embodiment shown in FIG. 13, the upper cart handle 280 comprises: (1) a right handle portion 282; (2) a left handle portion 284; and (3) a central handle portion 286.

The right handle portion 282 may comprise a substantially straight, elongated tube having, for example, a substantially circular (e.g., circular) cross-sectional profile. In alternative embodiments, the right handle portion 282 may have any other suitable cross-sectional profile (e.g., a square, rectangular, or oval profile). As shown in FIG. 9-11, the right handle portion 282 may be adapted to fit and slide within the right extendable frame member 241. In various embodiments, the right handle portion 282 has a cross sectional profile that at least generally corresponds to the cross sectional profile of the right extendable frame member 241. The dimensions of the inner surface of the right extendable frame member 241 may substantially correspond to (e.g., correspond to) the dimensions of the outer surface of the right handle portion 282 such that the right handle portion 282 can nest within the right extendable frame member 241 with sufficient clearance to facilitate smooth sliding and sufficient snugness to provide rigidity of the hand truck 200 when the upper cart handle 280 is in an extended position.

In particular embodiments, the right extendable frame member 241 is adapted to fit and slide within the first tube 254. In various embodiments, when the right handle portion 282 is nested within the right extendable frame member 241, and the right extendable frame member 241 is nested within the first tube 254, the right handle portion 282, the right extendable frame member 241, and the first tube 254 are maintained in a triple nested relationship with one another.

Similarly, the left handle portion 284 may comprise a substantially straight, elongated tube having, for example, a substantially circular (e.g., circular) profile. In alternative embodiments, the left handle portion 284 may have any other suitable profile (e.g., a square, rectangular, or oval profile). As shown in FIG. 13, the left handle portion 284 may be adapted to fit and slide within the left extendable frame member 245. In various embodiments, the left handle portion 284 has a cross sectional profile that at least generally corresponds to the cross sectional profile of the left extendable frame member 245. The dimensions of the inner surface of the left extendable frame member 245 may substantially correspond to (e.g., correspond to) the dimensions of the outer surface of the left handle portion 284 such that the left handle portion 284 can nest within the left extendable frame member 245 with sufficient clearance to facilitate smooth sliding and sufficient snugness to provide rigidity of the hand truck 200 when the upper cart handle 280 is in an extended position.

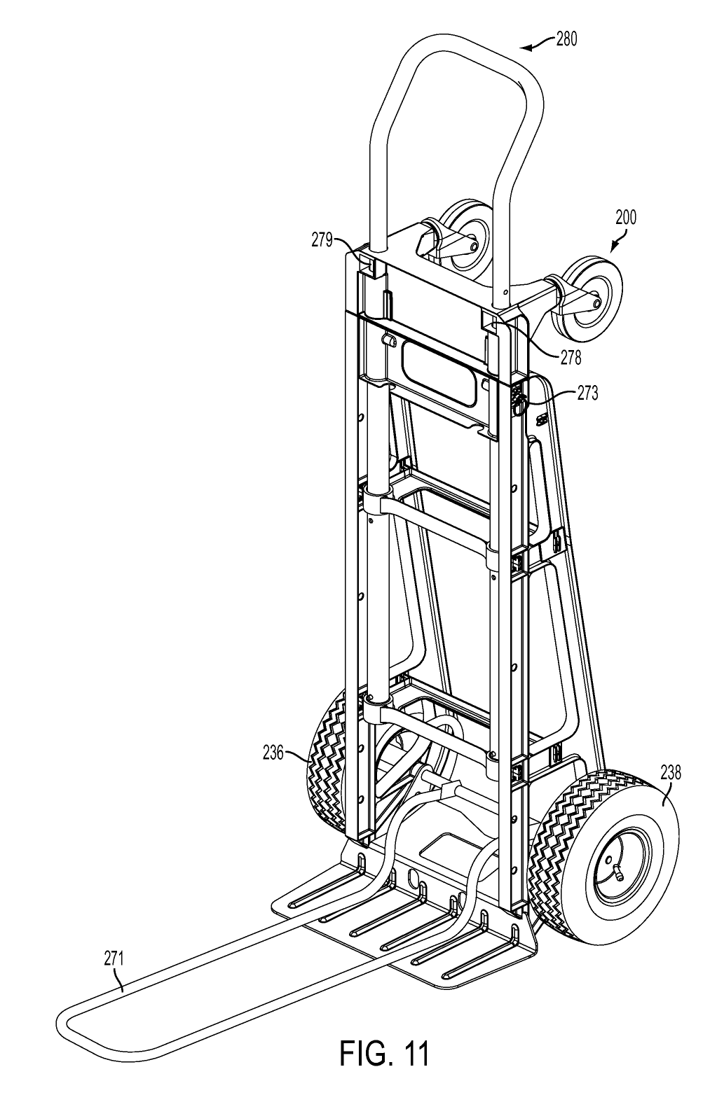

In particular embodiments, the left extendable frame member 245 is adapted to fit and slide within the second tube 264. As may be understood from FIG. 11, when the left handle portion 284 is nested within the left extendable frame member 245 and the left extendable frame member 245 is nested within the second tube 264, the left handle portion 284, the left extendable frame member 245, and the second tube 264 are maintained in a triple nested relationship with one another.

In various embodiments, the upper cart handle 280 is adapted for selective extension and retraction relative to the hand truck's base portion 201. FIG. 9 shows a particular embodiment of a hand truck 200 with the upper cart handle 280 in a retracted position. FIG. 11 shows the hand truck 200 with the upper cart handle 280 in an extended position. In various embodiments, the upper cart handle 280 further comprises a locking mechanism for locking the upper cart handle 280 at various lengths of extension. In the embodiment shown in FIGS. 9-11, the locking mechanism may include pins 279, 273 that lock the upper cart handle 280 in place by passing through openings in the sidewall of the right and left handle portions 282, 284 and the right and left extendable frame members 241, 245. Other embodiments may include any other suitable locking mechanism.

### Lower Cart Handle

As shown in FIGS. 9-15, the hand truck 200 may further include a lower cart handle 271 that may, for example, be useful in restricting the movement of larger loads that are supported by the hand truck 200. In particular embodiments, the lower cart handle 271 is substantially U- shaped and is rotatably mounted adjacent (e.g., to) the hand truck 200 to rotate from a retracted position shown in FIG. 14 (in which the lower cart handle 271 is substantially parallel to the hand truck's front face) to an extended position shown in FIG. 15 in which the lower cart handle 271 is substantially parallel to the hand truck's nose plate 220.

### Conversion and Extension of Hand Truck

As may be understood from FIGS. 1-4, to convert the hand truck 100 from a vertical operating arrangement (see FIG. 3) to the horizontal operating arrangement (see FIG. 4), a user may position the hand truck 100 adjacent a support surface so that the hand truck's primary wheels 136, 138 and secondary wheels 158, 160 are all in contact with the support surface. Once the hand truck 100 is in this horizontal operating arrangement, the user may: (1) remove the upper handle assembly 180 from the extendable frame assembly 140; (2) insert the handle assembly's right handle portion 182 into the right handle support 172; and (3) insert the left handle portion 184 into the left handle support 162.

The user may then selectively reposition the hand truck's extendable frame assembly 140 relative to its base portion 101 to adjust the length of the hand truck 100. This may, for example, allow the user to selectively move the hand truck 100 between a first configuration and a second, extended configuration. As noted above, the extendable frame assembly 140 may be selectively locked in an extended or unextended configuration with any suitable locking mechanism (e.g., a pin).

In various embodiments, similar techniques may also be used to selectively move the hand truck 100 between unextended and extended configurations while the hand truck 100 is in the upright, vertical operating arrangement.

### HAND TRUCK ADAPTED FOR TOOLLESS ASSEMBLY

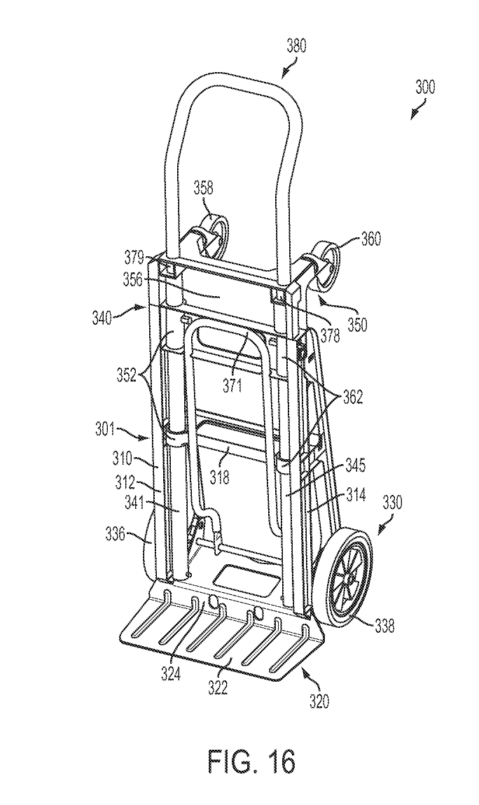

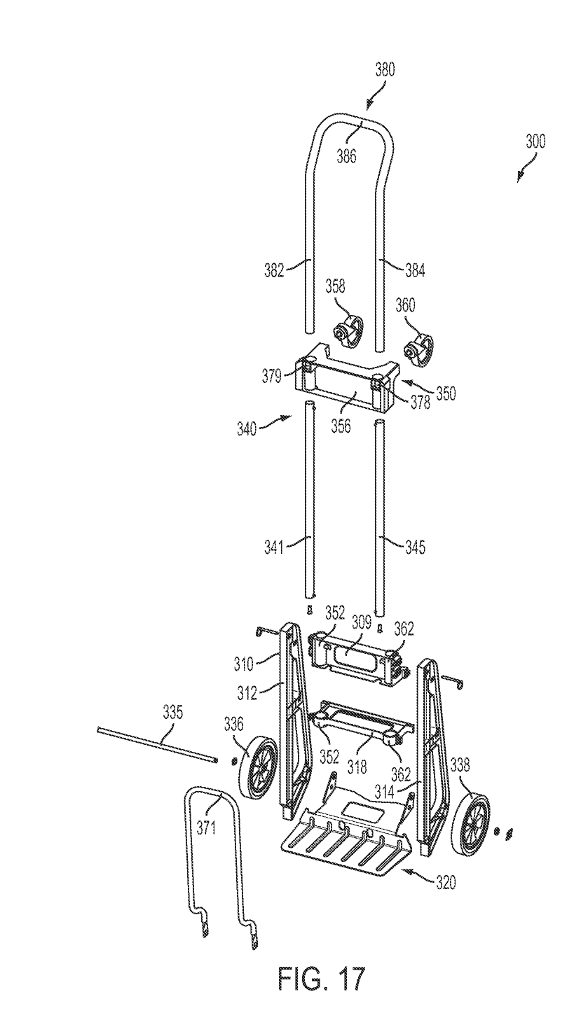

An alternative embodiment of a hand truck is shown in FIGS. 16-17. In this embodiment, the hand truck 300 may, for example, be adapted to allow a user to assemble the hand truck 300 at least substantially without the use of tools. However the basic structure and functionality of the hand truck 300 is similar to that of the hand truck 200 shown in FIGS. 9-15. For example, the embodiment of the hand truck 300 shown in FIGS. 16-17 includes: (1) a frame 310; (2) a nose plate 320; and (3) an extendable frame assembly 340. These various components are discussed in greater detail below.

### Frame

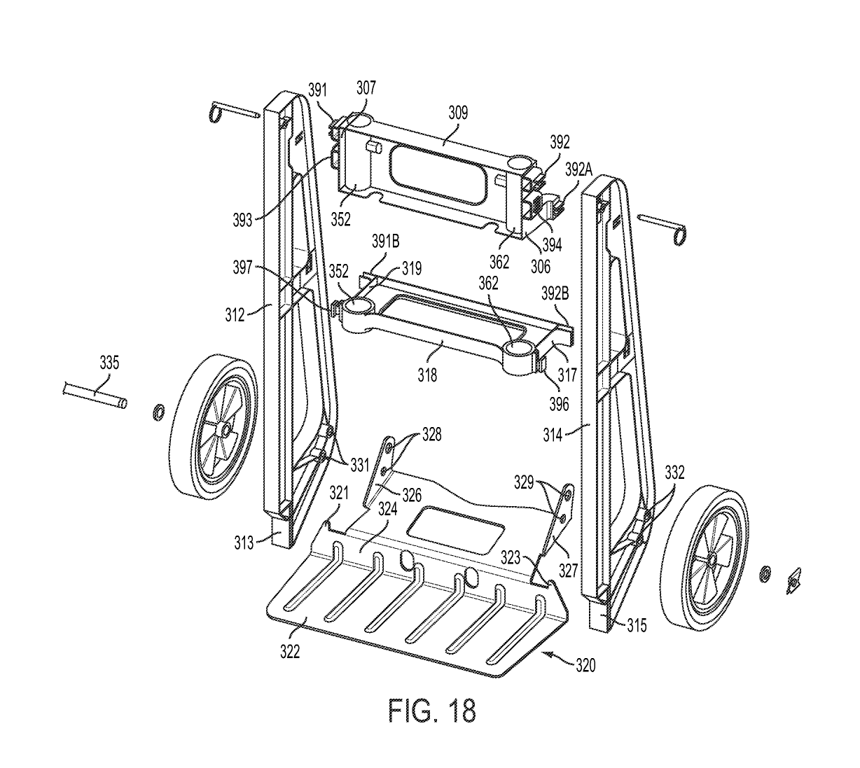

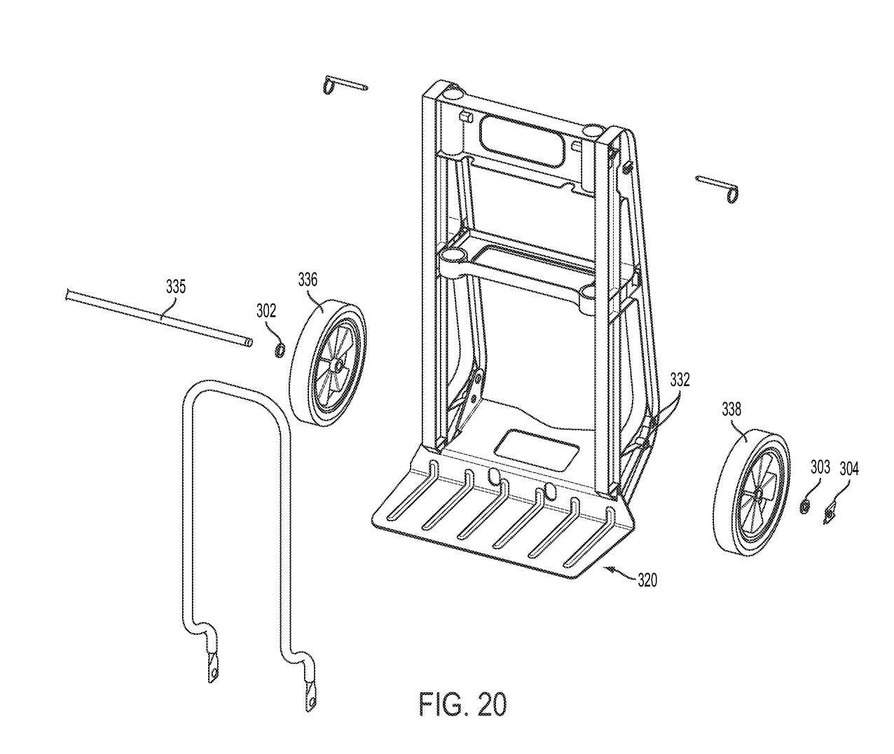

In the embodiment shown in FIGS. 16-24, the frame 310 may be substantially structurally similar to the frame 210 of the embodiment shown in FIG. 9. As may be understood from FIGS. 16-17, the frame 310 comprises: (1) a first side frame assembly 314; (2) a second side frame assembly 312; (3) a central connector 318; and (4) an upper central connector 309 (see FIG. 18). These various components are discussed in greater detail below.

### First Side Frame Assembly

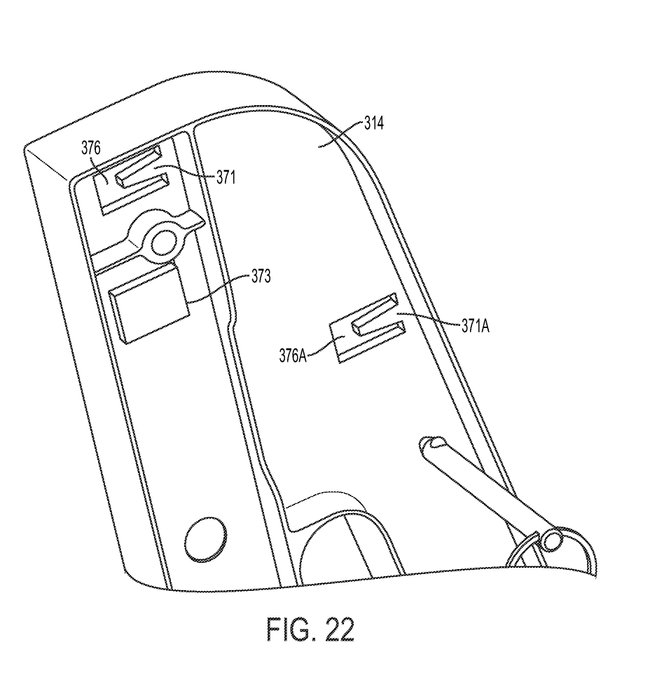

FIG. 22 shows a close up view of an upper portion of the first side frame assembly 314. In the embodiment shown in this figure, the first side frame assembly 314 defines two first openings 376, 376A on an upper portion of the first side frame assembly 314 and comprises two first fingers 371, 371A that are disposed adjacent (e.g., to) each respective first opening 376, 376A. In particular embodiments, the first openings 376, 376A have a substantially rectangular or trapezoidal profile. In various embodiments, each first finger 371, 371A is substantially planar (e.g., planar), substantially trapezoidal (e.g., trapezoidal), and extends substantially within (e.g., within) the plane of a corresponding first opening 376, 376A. In particular embodiments, the first finger 371, 371A may be wider at its base than at its distal end. In other embodiments, the first finger 371, 371A may be substantially rectangular (e.g., rectangular).

The first openings 376, 376A may be substantially structurally similar (e.g., identical) to one another, and the first fingers 371, 371A may be substantially structurally similar (e.g., identical) to one another. In particular embodiments, each first finger 371, 371A may be adapted to flex about the first finger's 371, 371A base portion (e.g., the first finger's proximal end).

As shown in FIG. 22, in particular embodiments, the first side frame assembly 314 further defines a second opening 373 that is substantially rectangular (e.g., rectangular) on an upper portion of the first side frame assembly 314. In this embodiment, the two first openings 376, 376A and the second opening 373 are spaced apart from one another.

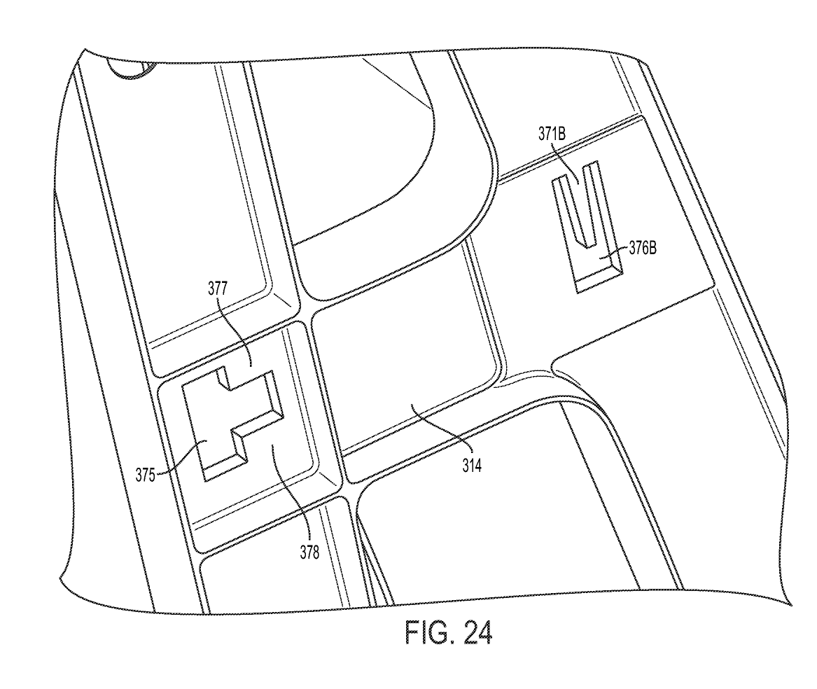

FIG. 24 shows a close up view of a middle portion of the first side frame assembly 314. As shown in this figure, the first side frame assembly 314 further defines a first opening 376B and a third opening 375 on a middle portion of the first side frame assembly 314 and comprises a first finger 371B adjacent the first opening 376B, and a first 377 and second 378 ledge disposed adjacent the third opening 375. In this embodiment, the first opening 376B and first finger 371B are substantially structurally similar (e.g., structurally identical) to the first openings 376, 376A and first fingers 371, 371A defined on the upper portion of the first side frame assembly 314.

As shown in FIG. 24, the third opening 375 is substantially T-shaped. In this embodiment, the first 377 and second 378 ledges are substantially rectangular (e.g., rectangular) and extend substantially within the plane of the third opening 375 substantially adjacent (e.g., to) two adjacent corners of the third opening 375. In particular embodiments, the first opening 376B and third opening 375 may be spaced a distance apart from one another, and may be disposed adjacent respective side portions of the first side frame assembly 314. In the embodiment shown in FIG. 24, the first opening 376B and third opening 375 are spaced apart a distance substantially equal (e.g., equal) to the front to back width of the central connector 318.

As shown in FIG. 18, the first side frame assembly 314 defines a pair of substantially circular (e.g., circular) first axle openings 332 adjacent a lower end of the first side frame assembly 314. In particular embodiments, the first axle openings 332 are sized to correspond to the radius of a hand truck's axle 335.

In the embodiment shown in FIG. 18, the first side frame assembly 314 defines a first nose plate support face 315 adjacent a bottom portion of a front face of the first side frame assembly 314 that is substantially flat (e.g., flat). In this embodiment, the first nose plate support face 315 extends between the inner and outer lateral faces of the first side frame assembly 314 and extends at least about two inches along a lower portion of the first side frame assembly's front face. In particular embodiments, the first nose plate support face 315 is adapted to be sized such that the height of the first nose plate support face 315 corresponds to the height of the nose plate's face plate 324.

### Second Side Frame Assembly

In the embodiment shown in FIG. 18, the second side frame assembly 312 is substantially structurally similar (e.g., structurally identical) to the first side frame assembly 314.

### Central Connector

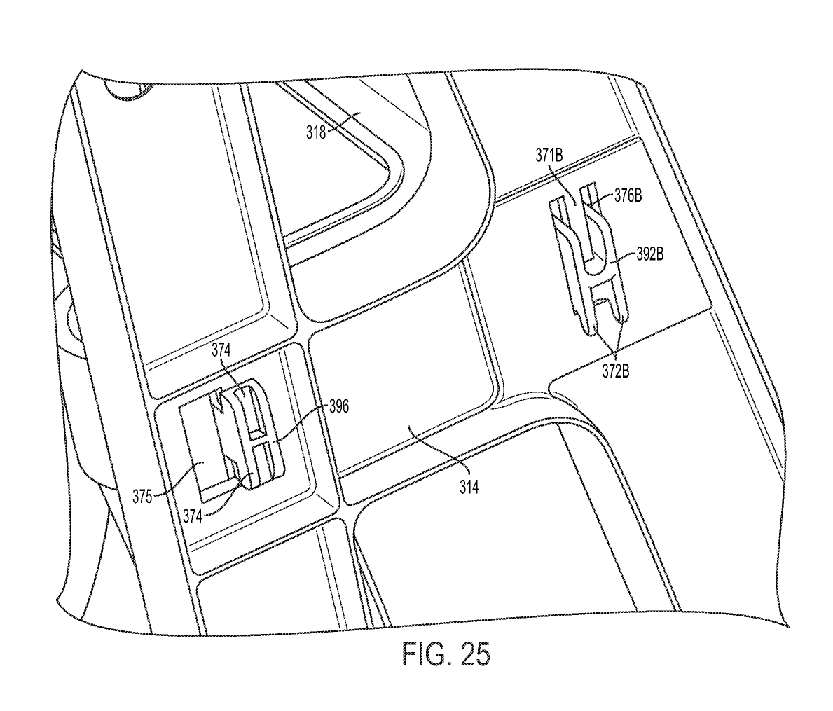

In the embodiment shown in FIG. 18, the central connector 318 comprises a first projection 392B that extends from a first side 317 of the central connector 318 and a second projection 396 that extends from the first side 317 of the central connector 318. As may be understood from FIG. 25, the first projection 392B is a substantially H-shaped (e.g., H-shaped) projection comprising two lips 372B that extend substantially perpendicularly (e.g., perpendicularly) downward from the first projection 392B beyond a first edge of the first projection 392B. In other embodiments, the first projection 392B may comprise a single lip, or more than two lips. In various embodiments, the first projection 392B may have a profile that at least generally corresponds to the profile of the first opening 376B.

In this embodiment, the second projection 396 is a substantially H-shaped projection that comprises two lips 374 that extend substantially perpendicularly (e.g., perpendicularly) from opposing ends of the second projection 396. In the embodiment shown in FIGS. 24 and 25, the first projection 392B and second projection 396 are spaced apart to correspond to the spacing between the first side frame assembly's first opening 376B and second opening 375.

In the embodiment shown in FIG. 18, the central connector's second side 319 is substantially structurally similar (e.g., structurally identical) to the central connector's first side 317 and includes a first projection 391B, and a second projection 397.

### Upper Central Connector

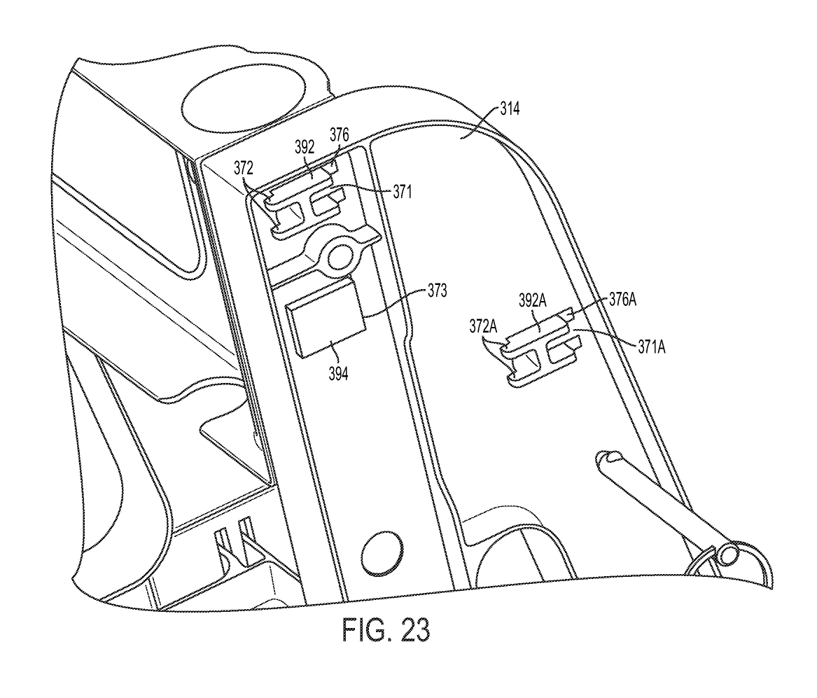

In the embodiment shown in FIG. 18, the upper central connector 309 comprises two first projections 392, 392A that extend from a first lateral side 306 of the upper central connector 309 and that are structurally similar (e.g., structurally identical) to the central connector's first projection 392B. The upper central connector 309 also comprises a substantially rectangular projection 394 that extends substantially perpendicularly from the upper central connector's 309 first side 306. In this embodiment, the two first projections 392, 392A and the substantially rectangular projection 394 are arranged on a first lateral side of the upper central connector 309 such that the positions of the two first projections 392, 392A and the substantially rectangular projection 394 relative to one another substantially correspond to the relative positions of the two first openings 376, 376A and the second opening 373 of the first side frame assembly 314 (see FIG. 23).

In the embodiment shown in FIG. 18, the upper central connector's second side 307 is substantially structurally similar (e.g., identical) to the upper central connector's first side 306, and includes a first projection 391, and a rectangular projection 393.

### Nose Plate

In the embodiment shown in FIG. 18, the nose plate 320 may be substantially structurally similar to the nose plate 220 of the embodiment shown in FIG. 9. As may be understood from FIG. 18, in particular embodiments, the nose plate 320 comprises: (1) a first lip 323 that extends upwardly from a first lateral end of the face plate 324 substantially in the same plane of the face plate 324; a second lip 321 that extends upwardly from a second lateral end of the face plate 324 substantially in the same plane of the face plate 324; (3) a first axle support 327 that extends substantially vertically (e.g., vertically) from a rear side portion of the nose plate 320 and that defines at least one first axle opening 329; and (4) a second axle support 326 that extends substantially vertically (e.g., vertically) from a rear side portion of the nose plate 320 and that defines at least one second axle opening 328.

In the embodiment shown in FIG. 18, the first and second lip 323, 321 are substantially co-planar (e.g., co-planar) and are disposed substantially perpendicular (e.g., perpendicular) to both the support plate 322 and to the support surface supporting the hand truck 300 when the hand truck 300 is in a vertical orientation. In this embodiment, the first and second lips 323, 321 each define an interior face that is substantially flat (e.g., flat). As may be understood from FIG. 18, the interior faces of the first and second lips 323, 321 are substantially co-facing (e.g., co-facing).

As shown in FIG. 18, the first axle support 329 and second axle support 328 are substantially planar (e.g., planar), substantially triangular (e.g., triangular) axle supports. In particular embodiments, the first and second axle supports 327, 326 are substantially structurally similar (e.g., structurally identical). As may be understood from FIG. 18, the first and second axle supports 327, 326 are disposed substantially parallel (e.g., parallel) to one another and substantially parallel (e.g., parallel) to the first and second side frame assemblies 314, 312. In the embodiment shown in FIG. 18, the first axle support 327 defines two first axle support openings 329 that are substantially circular (e.g., circular) openings sized to correspond to the radius of the axle 335. In this embodiment, the second axle support 326 defines two second axle support openings 328 that correspond in size and shape to the first axle support openings 329. In particular embodiments, the center of the respective radii of the first axle support openings 329 are substantially co-linear (e.g., co-linear) with the center of the respective radii of the corresponding second axle support openings 328.

### Extendable Frame Assembly

In the embodiment shown in FIG. 16, the extendable frame assembly 340 may be substantially structurally similar to the extendable frame assembly 240 of FIG. 9. As may be understood from FIGS. 16 and 17, the extendable frame assembly 340 includes: (1) a right extendable frame member 341; (2) a left extendable frame member 345; and (3) a connecting member 356 that extends between the right and left extendable frame members 341, 345 and connects the right and left extendable frame members 341, 345 together.

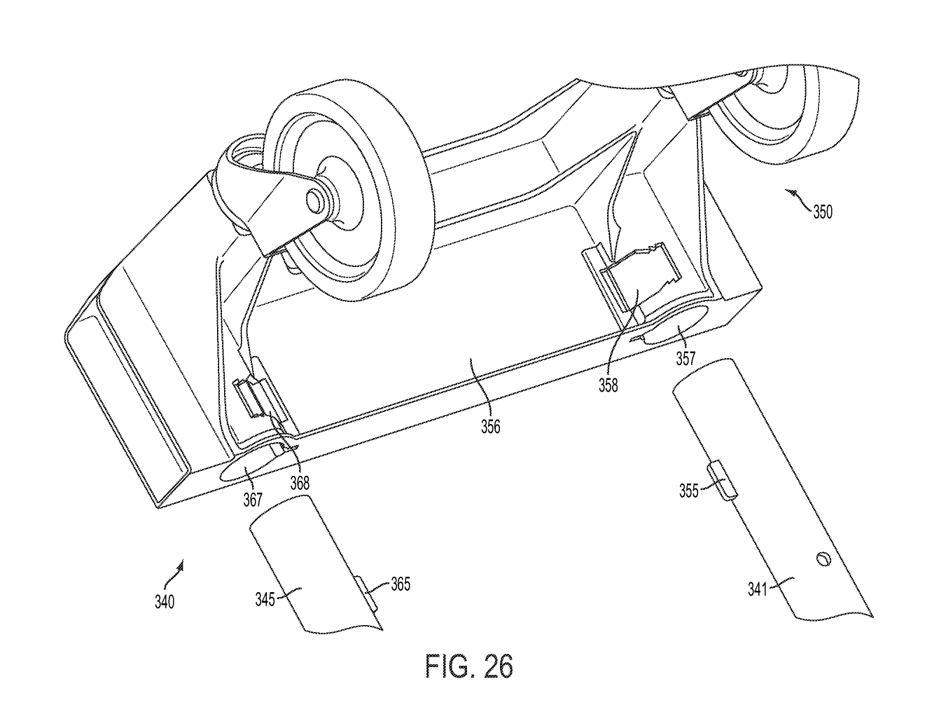

As shown in FIG. 26, in particular embodiments, the right extendable frame member 341 comprises an elongated tubular member with a first tab 355 that extends substantially radially outward a distance from an upper end of an outer surface of the right extendable frame member 341. In the embodiment shown in FIG. 26, the first tab 355 is substantially planar (e.g., planar) and substantially rectangular. In this embodiment, the left extendable frame member 345 comprises an elongated tubular member with a second tab 365 that is substantially structurally similar (e.g., identical) to the first tab 355 and disposed in substantially the same general location on the left extendable frame member 345 in which the first tab 355 is disposed on the right extendable frame member 341.

In the embodiment shown in FIG. 26, the central connector 356 defines a first extendable frame member support 357 on the right side of the bottom surface of the central connector 356 and defines a first tab notch 358 adjacent the first extendable frame member support 357. As may be understood from FIG. 26, the right extendable frame member support 357 has a profile that corresponds to the profile of the right extendable frame member 341 including the first tab 355. In this embodiment, the first tab notch 358 has a substantially rectangular profile that arcs along a curve having a radius that corresponds to the radius of the right extendable frame member 341 and narrows at one end. In particular embodiments, the first tab notch 358 is sized at least as wide as the first tab 355 at the first tab notch's 358 widest point. The first tab notch's 358 narrow end may be adapted to be sized sufficiently wide enough to allow the first tab 355 to rotate into the first tab notch's 358 narrow end and sufficiently narrow enough to squeeze and lock the first tab 355 in place when the first tab 355 is disposed within the first tab notch's 358 narrow end. In particular embodiments, the first tab notch 358 may include one or more ridges adjacent its narrow end to assist in locking the first tab 355 in place adjacent the first tab notch 358.

As shown in FIG. 26, the central connector 356 defines a second extendable frame member support 367 and second tab notch 368 that are substantially structurally similar (e.g., identical) to the first extendable frame member support 357 and first tab notch 358.

### TOOLLESS ASSEMBLY OF VARIOUS COMPONENTS OF AN EXEMPLARY HAND TRUCK

As may be understood from FIGS. 17-29, the hand truck 300 may be adapted to allow a user to assemble the hand truck 300 at least substantially without the use of tools.

### Frame Assembly

FIGS. 18-19 and 22-25 depict the assembly of a hand truck frame 310. As shown in FIG. 23, to assemble a hand truck frame 310, a user may insert the first projections 392, 392A of the upper central connector 309 into the corresponding first openings 376, 376A with the first lips 372, 372A oriented facing away from their respective first fingers 371, 371A, causing the first projections' respective central portions to engage the respective first fingers 371, 37A and to exert a force on the first fingers 371, 371A causing the first fingers 371, 371A to flex away from a home position about the first fingers' 371, 371A respective base portions. As the first fingers 371, 371A flex, they exert a force on the first projections' central portions that opposes the first projections' central portions' force on the first fingers 371, 371A, and pushes the first projections 392, 392A laterally away from the first fingers 371, 371A (e.g., away from the base of the first fingers 371, 371A) causing the first lips 372, 372A to engage an edge that defines the first openings 376, 376A. As the user continues to push the first projections 392, 392A through the first openings 376, 376A, the first fingers 371, 371A continue to flex and urge the first lips 372, 372A laterally until the first lips 372, 372A clear the edges that define the first opening 376, 376A and overlap with and engage a portion of the outside face of the first side frame assembly 314.

As may be understood from FIG. 23, when the first projections 392, 392A are fully inserted in the first openings 372, 372A the first fingers 371, 371A may return to (e.g., snap back to) the first fingers' 371, 371A unflexed position and engage the side of the first projections 392, 392A opposite their respective first lips 372, 372A. In particular embodiments, the first projections 392, 392A each define a cutout opposite their respective first lips 372, 372A, and the first fingers 371, 371A are adapted to be disposed within the respective cutouts when the first projections 392, 392A are in an attached position within the first openings 372, 372A.

In particular embodiments, the first fingers 371, 371A may be sized to correspond to the dimensions of the cutout plus a length of the first lips 372, 372A. As the first projections 392, 392A are at least fully inserted in the first openings 376, 376A, a user may snap the substantially rectangular projection 394 into the second opening 373. The first fingers 371, 371A and first lips 372, 372A are adapted to cooperate to lock the first projections 392, 392A in the first openings 376, 376 and maintain the first side assembly 314 adjacent the upper central connector 309. In the embodiment shown in FIG. 23, the substantially rectangular projection 394 may be adapted to maintain the upper central connector 309 in a substantially fixed lateral position relative to the first side frame assembly 314.

As may be understood from FIG. 25, a user may attach the central connector 318 to the first side frame assembly 314 by inserting the second projection 396 into the third opening 375 and sliding the second projection 396 laterally such that the second projection's lips 374 engage with the first and second ledges 377, 378, which are adapted to cooperate with the second projection's lips 374 to maintain the central connector 318 in a substantially fixed position adjacent the first side frame assembly 314. The user may then insert the central connector's 318 first projection 392B into the corresponding first opening 376B in substantially the same manner as the user inserted the upper central connector's first projections 392, 392A into the corresponding first openings 376, 376A. During this process, the first projection 392B is locked in place in the manner described above in regard to the upper central connector's first projections 392, 392A.

A user may then attach the second side frame assembly 312 to the second side 319 of the central connector 318, and the second side 307 of the upper central connector 309 in substantially the same manner (e.g., the same way) in which the user attached the first side frame assembly 314 to the first side 317 of the central connector 318, and the first side 306 upper central connector 309.

### Nose Plate Assembly

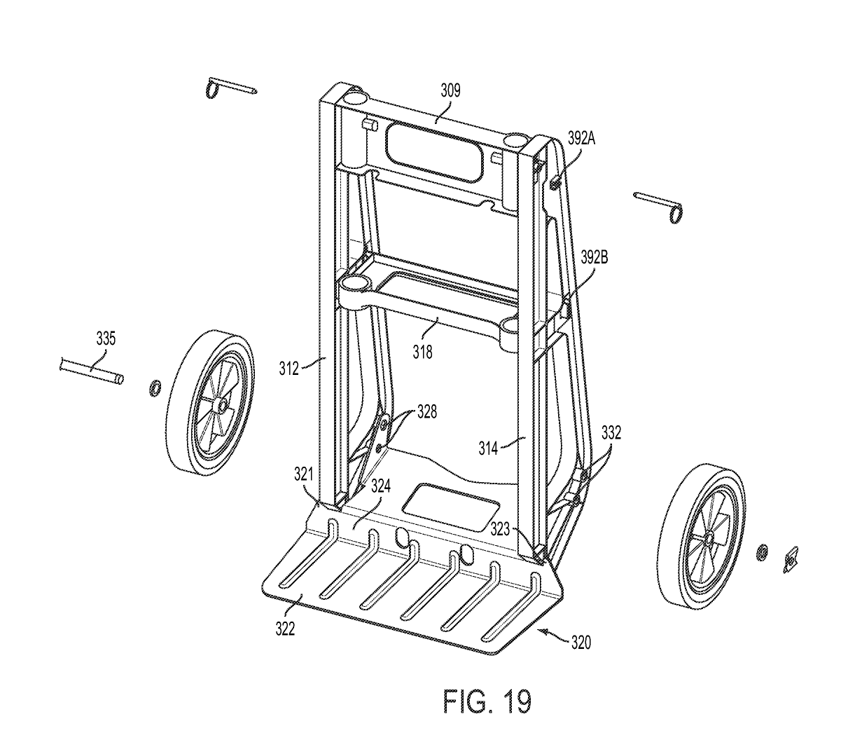

FIGS. 18-21 show exemplary steps for attaching a nose plate 320 to a hand truck's frame 310. As may be understood from FIGS. 18 and 19, a user may align the first axle support openings 329 with the corresponding first axle openings 332 of the first side frame assembly 314 and align the second axle support openings 328 with the corresponding second side frame assembly's second axle openings 331. A user may then insert an axle 335 (e.g., in the following sequence) through: (1) the second axle opening 331; (2) the second axle support opening 328; (3) the first axle support opening 329; and (4) the first axle opening 332.

The user may then affix two wheels to opposing ends of the axle 335 using any suitable means. For example, the user may use one or more clips 304 or other suitable fasteners to retain the axle 335 and wheels 336, 338 in a fixed, rotatable relationship to the hand truck.

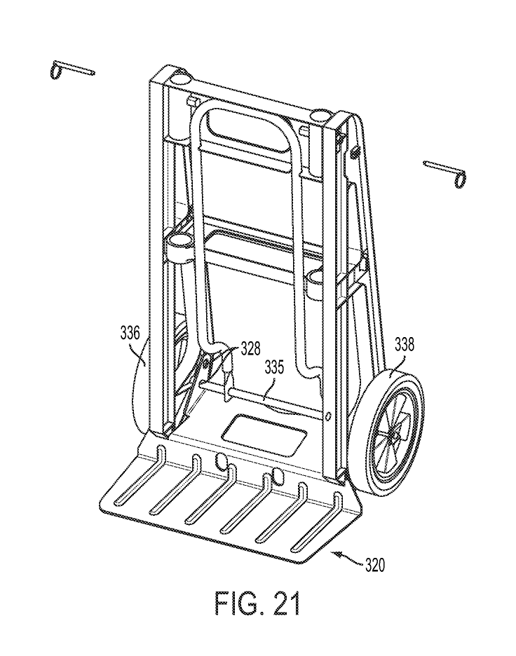

In particular embodiments, the axle 335 comprises an integrated stopper portion adjacent its first end and a circumferential recess adjacent its second end that is adapted to receive a portion of a retaining clip 304. In such an embodiment, the stopper and retaining clip 304 may cooperate to maintain the axle 335 in a substantially fixed lateral position relative to the hand truck. As may be understood by FIG. 21, in this embodiment, the axle 335 is adapted to support a rear portion of the nose plate 320. In particular embodiments, the retaining clip 304 may be adapted to allow a user to attach the retaining clip 304 to the axle 335 without using tools.

As may be understood from FIGS. 18 and 19, the face plate 324 is adapted to engage the first and second side frame assemblies' first and second nose plate support faces 315, 313 that exert a force against a rear portion of the face plate 324 that supports the nose plate's 320 support plate 322 and face plate 324. When a load is placed on the nose plate's support plate 322, the face plate 324 is adapted to exert a force against the first and second nose plate support faces 315, 313, which are adapted to exert an equal opposing force back on the face plate 324. The equal opposing force serves to support the nose plate 320, which supports the load.

When the nose plate 320 is attached to the hand truck 300, the first lip 323 is adapted to engage at least a portion of an outer lateral face of the first side frame assembly 314. Similarly, the second lip 321 is adapted to engage at least a portion of an outer lateral face of the second side frame assembly 312. In this arrangement, the first and second lips 323, 321 are adapted to cooperate to restrict the lateral movement of the nose plate 320 relative to the hand truck 300.

### Extendable Frame Assembly

FIGS. 26-28 show the steps of assembling the extendable frame assembly in a particular embodiment. As may be understood from FIGS. 26-28, a user may insert the respective ends of the right and left extendable frame members 341, 345 into the connecting member's first and second extendable frame member supports 357, 367. As may be understood from FIG. 26, a user may orient the right and left extendable frame members 341, 345 such that the profiles of the right and left extendable frame members 341, 345 including the first and second tab 355, 365 are substantially aligned with the first and second extendable frame member supports 357, 367 before inserting the right and left extendable frame members 341, 345 into the first and second extendable frame member supports 357, 367.

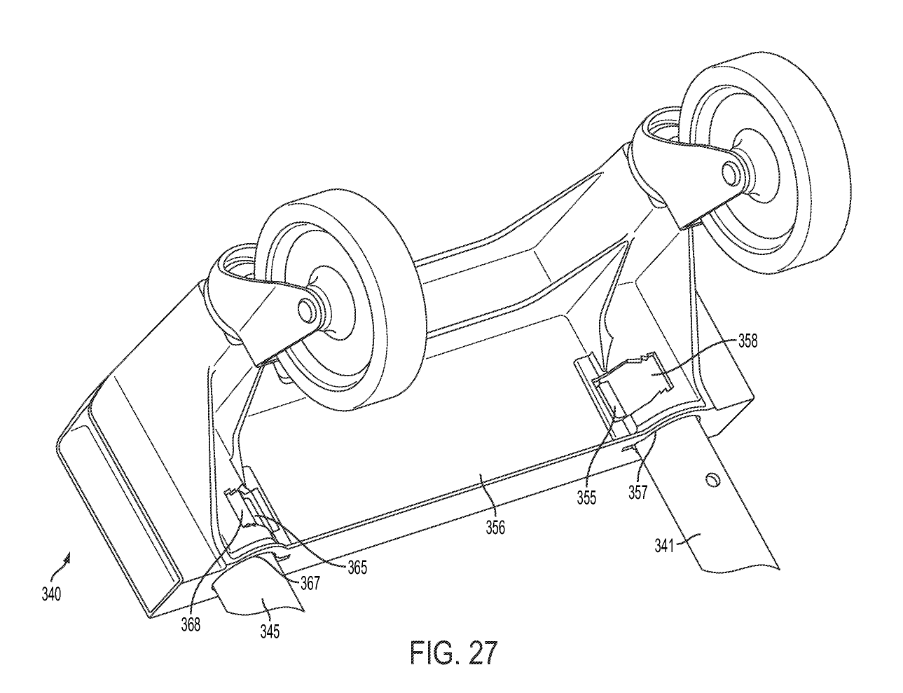

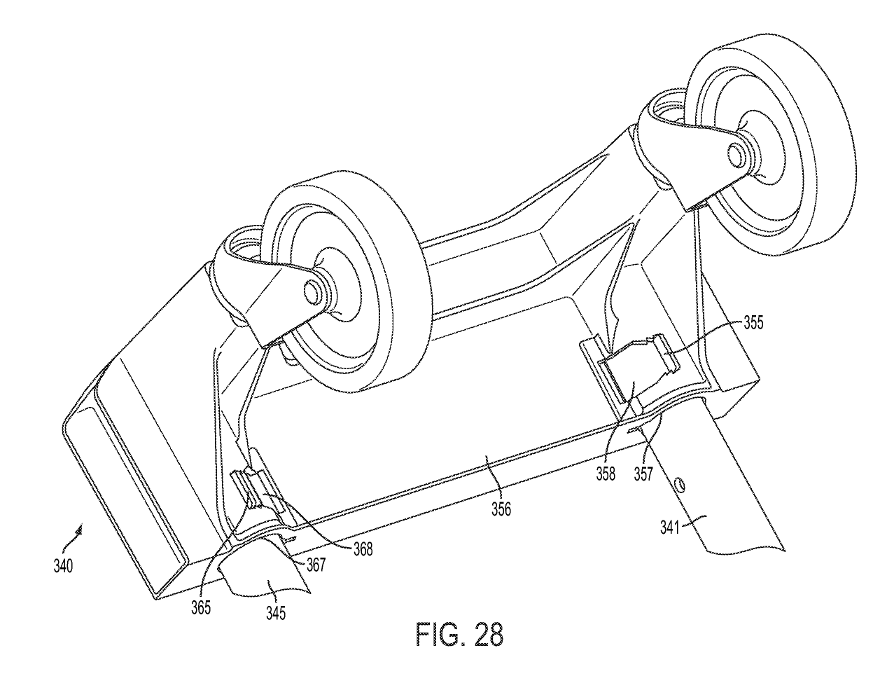

As may be understood from FIG. 27, when the right and left extendable frame members 341, 345 are fully inserted into the first and second extendable frame member supports 357, 367, the first tab 355 substantially aligns with the first tab notch 358, and the second tab 365 substantially aligns with the second tab notch 368. In particular embodiments, the right and left extendable frame members 341, 345 are adapted to allow a user to rotate the right and left extendable frame members 341, 345 within the first and second extendable frame member supports 357, 367 such that the first and second tab 355, 365 rotate within the first and second tab notches 358, 368. In the embodiment shown in FIGS. 27 and 28, the first and second tabs 355, 365 are adapted to rotate at least about thirty degrees within the first and second tab notches 358, 368.

As may be understood from FIGS. 27 and 28, as a user rotates the right extendable frame member 341, the first tab 355 rotates toward the narrow end of the first tab notch 358 until the first tab 355 begins to engage with the edges that define the first tab notch 358. As the first tab 355 continues to rotate, the edges that define the first tab notch 358 engage with and exert equal opposing forces on opposing ends of the first tab 355 that cooperate to lock the first tab 355 as well as the right side extendable frame member 341 in place. In this embodiment, the second tab 365 is adapted to lock within the second tab notch 368 in substantially the same manner. With the first and second tabs 355, 365 locked in place, the right extendable frame member 341, the left extendable frame member 345, and the connecting member 356 may, for example, be adapted to form a sturdy extendable frame for the hand truck 300.

### Assembly of Assembled Frame, Nose Plate, and Extendable Frame Assembly

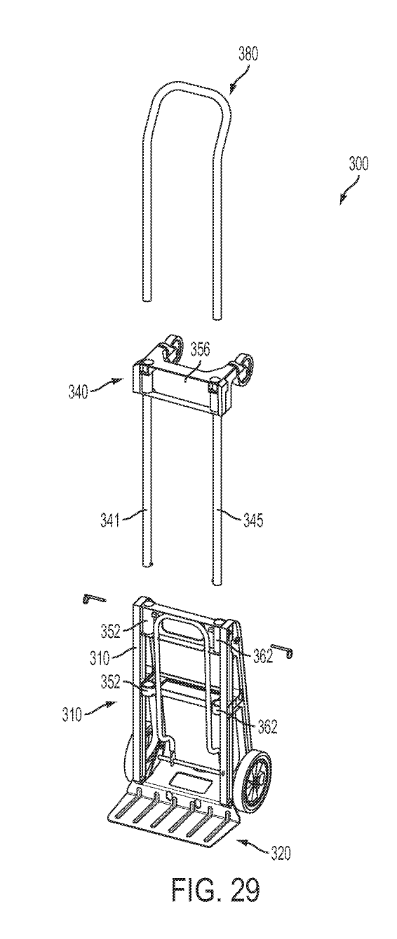

As may be understood form FIG. 29, once a user has assembled the hand truck frame 310, nose plate 320, and extendable frame assembly 340, the user may combine these components, along with an upper cart handle 380 into an assembled hand truck 300. To assemble the hand truck 300, the user may respectively insert the extendable frame assembly's 340 right and left extendable frame members 341, 345 into the right and left connectors 352, 362. The user may then insert the upper cart handle 380 into the extendable frame assembly 340 and lock the upper cart handle using any suitable locking mechanism (e.g., a pin).

### ALTERNATIVE EMBODIMENTS

Alternative embodiments of the hand truck 100 may comprise components that are, in some respects, similar to the various components described above. Selected distinguishing features of these alternative embodiments are discussed below.

### Nose Plate with Rolled Top Edge

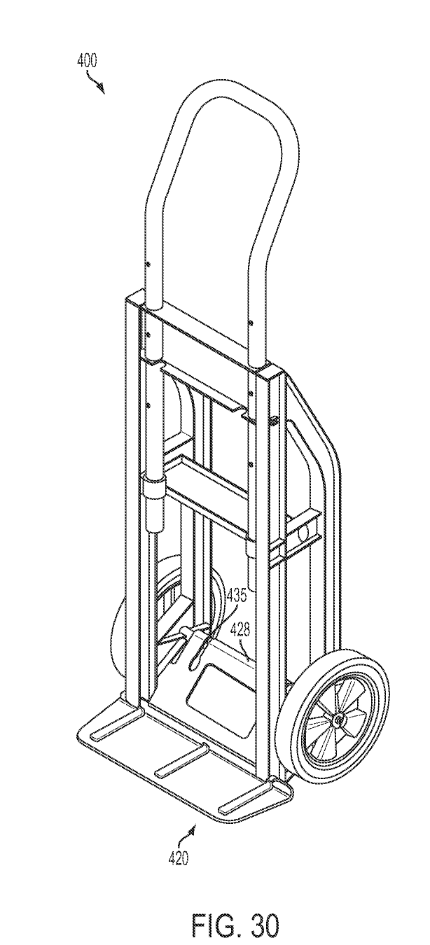

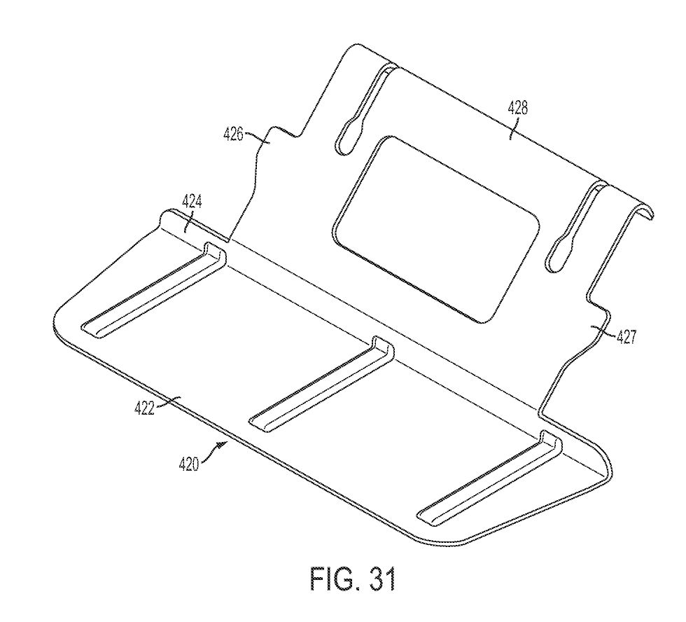

In particular embodiments, such as the embodiment shown in FIGS. 30-31, a hand truck 400 may include a nose plate 420 with a rolled top edge 428. As shown in FIG. 31, the rolled top edge 428 may extend rearwardly from a rear portion of the nose plate 420 in a curve that has a radius that at least generally corresponds to the radius of an axle. As may be understood from FIG. 30, the rolled top edge 428 may be adapted to engage (e.g., hookedly engage) an axle 435 and cooperate with the axle 435 to support a rear portion of the nose plate 420. In particular embodiments, the nose plate 420 may further comprise a first and second flange 426, 427 that extend substantially within a plane of the rear portion of the nose plate 420 in opposing lateral directions and are adapted to cooperate with the hand truck's frame to support the nose plate's support plate 422. In various embodiments, the first and second flanges 426, 427 may be disposed within openings defined in the hand truck's frame that correspond to the dimensions of the first and second flanges 426, 427. The first and second flanges 426, 427 may be adapted to engage the portions of the hand truck's frame that define the corresponding openings, and the hand truck's frame may be adapted to exert opposing forces on the first and second flanges 426, 427 to maintain the nose plate 420 in place adjacent a lower end of the hand truck's frame.

### Modular Tool Inserts

In particular embodiments, one or more of the hand truck's cross members (e.g., the central connector 318 or the upper central connector 309) may include a task module that is adapted to be selectively attached (e.g., using hooks, snaps, or any other suitable selective mechanical fastening arrangement) adjacent the cross member. Such task modules may be physically configured to assist a user in performing one or more specialized tasks, such as painting, performing routine repairs, or gardening. In various embodiments, the central connector 318 (or other hand truck component) is adapted to selectively support any of a plurality of different task modules (e.g., a paint bucket module may define at least one support opening that is adapted to support a paint bucket). This may allow a user to selectively tailor the current structure of the hand truck to assist in completing a particular kind of task.

### CONCLUSION

Many modifications and other embodiments of the invention will come to mind to one skilled in the art to which this invention pertains having the benefits of the teachings presented in the foregoing descriptions and the associated drawings. For example, as will be understood by one skilled in the relevant field in life of this disclosure, the invention may take form in a variety of different mechanical and operational configurations. Therefore, it is to be understood that the invention is not to be limited to the specific embodiments disclosed and that modifications and other embodiments are intended to be included within the scope of the appended exemplary concepts. Although specific terms are employed herein, they are used in a generic and descriptive sense only and not for the purposes of limitation.

1. A hand truck comprising:
(A) a frame assembly comprising:
a first side frame assembly;
a second side frame assembly that is spaced apart from and co-facing the first side frame assembly; and
at least one central connector that extends between the first side frame assembly and the second side frame assembly;
(B) a nose plate disposed adjacent a lower end of the frame assembly; and
(C) a wheel assembly that is attached adjacent a lower end of the frame assembly, the wheel assembly comprising at least one wheel that is adapted to facilitate the rolling movement of the hand truck over a support surface supporting the hand truck, wherein:
the nose plate is adapted to allow a user to attach the nose plate to the hand truck substantially without the use of tools.

2. The hand truck of claim 1, wherein:
the wheel assembly comprises an axle that is adapted to support the at least one wheel; and
the axle is adapted to support a rear portion of the nose plate.

3. The hand truck of claim 1, wherein:
at least a first portion of the nose plate is adapted to engage at least a portion of the first side frame assembly;
at least a second portion of the nose plate is adapted to engage at least a portion of the second side frame assembly;
the at least a portion of the first side frame assembly is adapted to cooperate with the at least a first portion of the nose plate to support a first side of the nose plate; and
the at least a portion of the second side frame assembly is adapted to cooperate with the at least a second portion of the nose plate to support a second side of the nose plate.

4. The hand truck of claim 3, wherein:
the nose plate comprises a rolled top edge adjacent the rear portion of the nose plate that has a radius that corresponds to a radius of the axle; and
the rolled top edge is adapted to cooperate with the axle to support the rear portion of the nose plate.

5. The hand truck of claim 4, wherein the rolled top edge is adapted to hook over the axle.

6. The hand truck of claim 1, wherein:
the nose plate defines at least one axle support adjacent a rear portion of the nose plate; and
the at least one axle support is adapted to cooperate with the axle to support the rear portion of the nose plate.

7. The hand truck of claim 1, wherein:
the nose plate comprises a first flange that protrudes from a first side of the nose plate;
the nose plate comprises a second flange that protrudes from a second side of the nose plate;
the first side frame assembly defines a first locking web adjacent a lower portion of an interior portion of the first side frame assembly;
the second side frame assembly defines a second locking web adjacent a lower portion of an interior portion of the second side frame assembly;
the first flange is adapted to engage the first locking web and the second flange is adapted to engage the second locking web; and
the first flange is adapted to cooperate with the first locking web and the second flange is adapted to cooperate with the second locking web to support the nose plate.

8. The hand truck of claim 1, wherein:
the first side frame assembly defines a first nose plate support face adjacent a lower portion of a front portion of the first side frame assembly;
the second side frame assembly defines a second nose plate support face adjacent a lower portion of a front portion of the second side frame assembly;
the nose plate comprises a faceplate having a first lateral end and a second lateral end; and
the nose plate is adapted so that, when it is installed adjacent the rest of the hand truck: (1) the first end of the faceplate engages the first nose plate support face and the second end of the faceplate engages the second nose plate support face; and (2) the first end of the faceplate cooperates with the first nose plate support face and the second end of the faceplate cooperates with the second nose plate support face to support the nose plate.

9. The hand truck of claim 1, wherein:
the first end of the faceplate comprises a first lip that extends upwardly adjacent an outside edge of the first side frame assembly when the nose plate is attached to the hand truck;
the second end of the faceplate comprises a second lip that extends upwardly adjacent an outside edge of the second side frame assembly when the nose plate is attached to the hand truck;
the first lip is adapted to engage the outside edge of the first side frame assembly to maintain the nose plate in a substantially fixed lateral position relative to the frame assembly; and
the second lip is adapted to engage the outside edge of the second side frame assembly to maintain the nose plate in a substantially fixed lateral position relative to the frame assembly.

10. An assembly comprising:
(a) a first part defining at least one opening and comprising a finger that is adapted to flex and that is disposed adjacent the at least one opening; and
(b) a second part comprising at least one projection that extends from the second part and that comprises a first end having a lip and a second end, wherein:
the at least one projection is adapted to allow a user to insert the at least one projection into the at least one opening and to thereby flex the finger about a base of the finger away from a home position of the finger as the user inserts the at least one projection through the at least one opening;
the lip of the at least one projection is adapted to engage at least a portion of an outer face of the first part when the user at least fully inserts the at least one projection through the at least one opening;
the finger is adapted to return to the home position and engage the second end of the projection when the lip engages the at least the portion of the outer face of the first part; and
the finger and the lip are adapted to cooperate to maintain the first part and the second part in a connected relationship.

11. The assembly of claim 10, wherein the finger is disposed substantially within a plane of the at least one opening.

12. The assembly of claim 10, wherein:
the at least one projection comprises an H-shaped projection; and
the finger is adapted to engage a central portion of the H-shaped projection when the lip engages the at least a portion of the outer face of the first part.

13. The assembly of claim 12, wherein the finger is disposed within a recess defined by said H-shaped projection when the H-shaped projection is fully inserted into the at least one opening.

14. The assembly of claim 10, wherein the at least one opening is sized to correspond to a profile of the at least one projection.

15. The assembly of claim 10, wherein:
the first part is a first side frame assembly of a hand truck;
the second part is a central connector of the hand truck; and
the at least one opening and the at least one projection are adapted to allow a user to attach the central connector to the first side frame assembly substantially without the use of tools.

16. The assembly of claim 10, wherein:
the first part defines a substantially T-shaped opening; and
the second part comprises a second projection that extends from the second part and that comprises at least one lip, wherein:
the second projection is adapted to allow the user to insert the second projection into a wide portion of the T-shaped opening and slide the second projection laterally so that at least a portion of the second projection's at least one lip engages a particular portion of an outer face of the first part; and
the second projection is adapted to maintain the first part adjacent the second part when the second projection is disposed within the T-shaped opening and the at least a portion of the second projection's lip is engaging the particular portion of the outer face of the first part.

17. The assembly of claim 16, wherein the first part and second part are adapted to allow the user to attach the first part to the second part by following the steps of:
(a) inserting the second projection into the wide portion of the T-shaped opening;
(b) sliding the second projection laterally within the T-shaped opening until the at least a portion of the second projection's at least one lip engages the at least a portion of the outer face of the first part; and
(c) inserting the first projection into the first opening.

18. The assembly of claim 16, wherein the assembly is a hand truck.

19. A hand truck comprising:
(A) a frame assembly comprising:
a first elongated tubular member comprising a first tab that extends outwardly a distance from a first end of the first elongated tubular member;
a second elongated tubular member comprising a second tab that extends outwardly a distance from a first end of the second elongated tubular member; and
at least one central connector that extends between the first elongated tubular member and the second elongated tubular member and that defines:
(a) a first opening that is sized to correspond to the profile of the first elongated tubular member and that is adapted to allow a user to insert the first elongated tubular member into the opening;
(b) a second opening that is sized to correspond to the profile of the second elongated tubular member and that is adapted to allow a user to insert the second elongated tubular member into the opening;
(c) a first tab notch adjacent the first opening, wherein the first tab substantially aligns with the first tab notch when the user at least fully inserts the first elongated tubular member into the first opening; and
(d) a second tab notch adjacent the second opening, wherein the second tab substantially aligns with the second tab notch when the user at least fully inserts the second elongated tubular member into the second opening;
(B) a nose plate attached adjacent a lower end of the frame assembly; and
(C) a wheel assembly that is attached adjacent a lower end of the frame assembly, the wheel assembly comprising at least one wheel that is adapted to facilitate the rolling movement of the hand truck over a support surface supporting the hand truck, wherein:
the first elongated tubular member is adapted to allow a user to rotate the first tab within the first tab notch after the user has at least fully inserted the first elongated tubular member into the first opening;
the portions of the central connector that define the first tab notch are adapted to engage and exert opposing forces on the first tab when the user twists the first tab within the first tab notch;
the first tab notch is adapted to lock the first tab using the opposing forces;
the second elongated tubular member is adapted to allow a user to rotate the second tab within the second tab notch after the user has at least fully inserted the second elongated tubular member into the second opening;
the portions of the central connector that define the second tab notch are adapted to engage and exert opposing forces on the second tab when the user twists the second tab within the second tab notch; and
the second tab notch is adapted to lock the second tab using the opposing forces.

20. The hand truck of claim 19, wherein the at least one central connector is a secondary wheel assembly.

21. The hand truck of claim 19, wherein the first and second tabs are substantially planar.
